(19) United States
(12) Patent Application Publication
(10) Pub. No.: US 2025/0125738 A1
(43) Pub. Date: Apr. 17, 2025

(54) SYSTEMS AND METHODS FOR CONTROLLING SYNCHRONOUS RECTIFIERS IN POWER CONVERTERS WITH ZERO VOLTAGE SWITCHING

(71) Applicant: ON-BRIGHT INTEGRATIONS CO., INC., Shanghai (CN)

(72) Inventors: CHUNSHENG ZHAO, Shanghai (CN); LIEYI FANG, Shanghai (CN)

(21) Appl. No.: 18/985,771

(22) Filed: Dec. 18, 2024

Related U.S. Application Data
(63) Continuation of application No. 17/714,821, filed on Apr. 6, 2022.

(30) Foreign Application Priority Data
Apr. 8, 2021 (CN) 202110379198.9

(51) Int. Cl. H02M 3/335; H02M 1/08; H02M 7/217

(52) U.S. Cl. CPC H02M 3/33592; H02M 1/08; H02M 3/33507; H02M 7/217

(57) ABSTRACT

System and method for controlling synchronous rectification. For example, a system for controlling synchronous rectification includes: a first control-signal generator configured to generate a first control signal; a second control-signal generator configured to receive the first control signal for a first switching cycle and generate a second control signal for a second switching cycle based at least in part on the first control signal for the first switching cycle, the first switching cycle preceding the second switching cycle; and a driver configured to receive the first control signal and generate a drive voltage based at least in part on the first control signal; wherein the second control-signal generator is further configured to: process information associated with the first control signal; determine a first time duration when the first control signal remains at a first logic level during the first switching cycle.

### 1. CROSS-REFERENCES TO RELATED APPLICATIONS

This application claims priority to Chinese Patent Application No. 202110379198.9, filed Apr. 8, 2021, incorporated by reference herein for all purposes.

### 2. BACKGROUND OF THE INVENTION

Certain embodiments of the present invention are directed to circuits. More particularly, some embodiments of the invention provide systems and methods for controlling synchronous rectifiers. Merely by way of example, some embodiments of the invention have been applied to flyback power converters with zero voltage switching. But it would be recognized that the invention has a much broader range of applicability.

With development of the modern electronics, the operation voltage of many electronic circuits has become lower, but the operation current of the electronic circuits have become higher. Accordingly, the overall power consumption of the electronic circuits has become more important for circuit design. In a conventional power converter, the rectification circuit on the secondary side often employs a Schottky diode, but as the operation voltage decreases, the power efficiency of the rectification circuit also decreases. To improve power efficiency, the synchronous rectification technique has been used for power converters that have low operation voltage and high operation current. Usually, the synchronous rectification technique achieves high power efficiency by replacing the Schottky diode with a power metal-oxide-semiconductor field-effect transistors (MOSFET) with low on-resistance.

FIG. 1 is a simplified diagram showing a conventional flyback power converter with zero voltage switching and synchronous rectification. As shown in FIG. 1, the flyback power converter 100 includes a primary winding 110 and a secondary winding 112, which are parts of a transformer (e.g., a transformer T). The transformer (e.g., a transformer T) includes the primary winding 110, the secondary winding 112, and auxiliary windings 2114 and 2132. On the primary side, the flyback power converter 100 also includes a bridge rectifier 120 (e.g., a rectifier that includes four diodes), a resistor 130 (e.g., Rₛₜ), a resistor 132 (e.g., R_{cs}), a capacitor 140 (e.g., C_{bulk}), a capacitor 142 (e.g., Cₚ), a transistor 150 (e.g., a power MOSFET MS1), a pulse-width-modulation controller 152 (e.g., a controller chip U1), a transistor 2112 (e.g., the MOSFET MS3), a capacitor 2116 (e.g., Cₛ), a diode 2120 (e.g., Dₛₙ), a resistor 2122 (e.g., Rₛₙ), a capacitor 2124 (e.g., Cₛₙ), and a diode 2130 (e.g., Dₚ). Additionally, on the secondary side, the flyback power converter 100 also includes a controller 160 for synchronous rectification (e.g., a controller chip U2), a capacitor 170 (e.g., Cₒᵤₜ), a transistor 180 (e.g., a MOSFET MS2), and a body diode 190 (e.g., a parasitic diode of the transistor 180). For example, the controller 160 for synchronous rectification (e.g., a controller chip U2) and the transistor 180 (e.g., a MOSFET MS2) are parts of a synchronous rectifier.

As shown in FIG. 1, an alternating current (AC) input voltage 122 is rectified by the bridge rectifier 120 and then filtered by the capacitor 140 (e.g., C_{bulk}). One terminal of the capacitor 140 (e.g., C_{bulk}) is connected to one terminal of the resistor 130 (e.g., Rₛₜ), one terminal of the resistor 2122 (e.g., Rₛₙ), one terminal of the capacitor 2124 (e.g., Cₛₙ), and one terminal of the primary winding 110. Another terminal of the resistor 2122 (e.g., Rₛₙ) and another terminal of the capacitor 2124 (e.g., Cₛₙ) are connected to the cathode of the diode 2120 (e.g., Dₛₙ). Another terminal of the primary winding 110 is connected to the anode of the diode 2120 (e.g., Dₛₙ) and the drain terminal of the transistor 150 (e.g., the MOSFET MS1). Another terminal of the resistor 130 (e.g., Rₛₜ) is connected to one terminal of the capacitor 142 (e.g., Cₚ), a terminal 154 (e.g., VCC) of the pulse-width-modulation controller 152 (e.g., the controller chip U1), and the cathode of the diode 2130 (e.g., Dₚ). Another terminal of the capacitor 142 (e.g., Cₚ) is connected to one terminal of the auxiliary winding 2132 and biased to the ground voltage on the primary side. Another terminal of the auxiliary winding 2132 is connected to the anode of the diode 2130 (e.g., Dₚ).

Additionally, a terminal 156 (e.g., gate1) of the pulse-width-modulation controller 152 (e.g., the controller chip U1) is connected to the gate terminal of the transistor 150 (e.g., the MOSFET MS1). The pulse-width-modulation controller 152 (e.g., the controller chip U1) outputs a voltage 148 through the terminal 156 (e.g., gate1) to the gate terminal of the transistor 150 (e.g., the MOSFET MS1). A terminal 158 (e.g., CS) of the pulse-width-modulation controller 152 (e.g., the controller chip U1) is connected to the source terminal of the transistor 150 (e.g., the MOSFET MS1) and is also connected to one terminal of the resistor 132 (e.g., R_{cs}). Another terminal of the resistor 132 (e.g., R_{cs}) and a terminal 144 (e.g., GND) of the pulse-width-modulation controller 152 (e.g., the controller chip U1) both are biased to the ground voltage on the primary side.

One terminal of the secondary winding 112 is connected to the cathode of the body diode 190, the drain terminal of the transistor 180 (e.g., the MOSFET MS2), and a terminal 162 (e.g., V_{d}) of the controller 160 for synchronous rectification (e.g., the controller chip U2). Additionally, another terminal of the secondary winding 112 is connected to one terminal of the capacitor 170 (e.g., Cₒᵤₜ) and is also connected to a terminal 164 (e.g., Vᵢₙ) of the controller 160 for synchronous rectification (e.g., the controller chip U2). The source terminal of the transistor 180 (e.g., the MOSFET MS2) is connected to the anode of the body diode 190, and the gate terminal of the transistor 180 (e.g., the MOSFET MS2) is connected to a terminal 166 (e.g., gate2) of the controller 160 for synchronous rectification (e.g., the controller chip U2). Another terminal of the capacitor 170 (e.g., Cₒᵤₜ), the source terminal of the transistor 180 (e.g., the MOSFET MS2), and a terminal 168 (e.g., GND) of the controller 160 for synchronous rectification (e.g., the controller chip U2) all are biased to the ground voltage on the secondary side. The output voltage 172 (e.g., Vₒᵤₜ) represents the voltage drop between the two terminals of the capacitor 170 (e.g., Cₒᵤₜ). Also as shown in FIG. 1, a current 146 flows through the primary winding 110, and a current 192 (e.g., I_{sec}) flows through the secondary winding 112. The controller 160 for synchronous rectification (e.g., the controller chip U2) receives a voltage 194 through the terminal 162 (e.g., V_{d}) from the drain terminal of the transistor 180 (e.g., the MOSFET MS2), and outputs a voltage 196 through the terminal 166 (e.g., gate2) to the gate terminal of the transistor 180 (e.g., the MOSFET MS2) in order to turn on and/or turn off the transistor 180 (e.g., the MOSFET MS2).

Additionally, a terminal 2110 (e.g., gate3) of the pulse-width-modulation controller 152 (e.g., the controller chip U1) is connected to the gate terminal of the transistor 2112 (e.g., the MOSFET MS3). The drain terminal of the transistor 2112 (e.g., the MOSFET MS3) is connected to one terminal of the auxiliary winding 2114. Another terminal of the auxiliary winding 2114 is connected to one terminal of the capacitor 2116 (e.g., Cₛ), and another terminal of the capacitor 2116 (e.g., Cₛ) and the source terminal of the transistor 2112 (e.g., the MOSFET MS3) both are biased to the ground voltage on the primary side. The capacitor 2116 (e.g., Cₛ) and the transistor 2112 (e.g., the MOSFET MS3) are used to provide zero voltage switching (ZVS) on the primary side of the flyback power converter 100 through the terminal 2110 (e.g., gate3) of the pulse-width-modulation controller 152 (e.g., the controller chip U1).

For the flyback power converter 100, the controller 160 for synchronous rectification (e.g., the controller chip U2) and the transistor 180 (e.g., the MOSFET MS2) are parts of a synchronous rectification system (e.g., a synchronous rectifier). The synchronous rectification system replaces a Schottky diode in order to raise power efficiency (e.g., reducing heat generation) and improve current generation capability. Such synchronous rectification system often is used in a system with a large output current.

FIG. 2 is a simplified diagram showing another conventional flyback power converter with zero voltage switching and synchronous rectification. As shown in FIG. 2, the flyback power converter 200 includes a primary winding 210 and a secondary winding 212, which are parts of a transformer (e.g., a transformer T). The transformer (e.g., a transformer T) includes the primary winding 210, the secondary winding 212, and auxiliary windings 2214 and 2232. On the primary side, the flyback power converter 200 also includes a bridge rectifier 220 (e.g., a rectifier that includes four diodes), a resistor 230 (e.g., Rₛₜ), a resistor 232 (e.g., R_{cs}), a capacitor 240 (e.g., C_{bulk}), a capacitor 242 (e.g., Cₚ), a transistor 250 (e.g., a power MOSFET MS1), a pulse-width-modulation controller 252 (e.g., a controller chip U1), a transistor 2212 (e.g., the MOSFET MS3), a capacitor 2216 (e.g., Cₛ), a diode 2220 (e.g., Dₛₙ), a resistor 2222 (e.g., Rₛₙ), a capacitor 2224 (e.g., Cₛₙ), and a diode 2230 (e.g., Dₚ). Additionally, on the secondary side, the flyback power converter 200 also includes a controller 260 for synchronous rectification (e.g., a controller chip U2), a capacitor 270 (e.g., Cₒᵤₜ), and a transistor 280 (e.g., a MOSFET MS2), and a body diode 290 (e.g., a parasitic diode of the transistor 280). For example, the controller 260 for synchronous rectification (e.g., a controller chip U2) and the transistor 280 (e.g., a MOSFET MS2) are parts of a synchronous rectifier.

As shown in FIG. 2, an alternating current (AC) input voltage 222 is rectified by the bridge rectifier 220 and then filtered by the capacitor 240 (e.g., C_{bulk}). One terminal of the capacitor 240 (e.g., C_{bulk}) is connected to one terminal of the resistor 230 (e.g., Rₛₜ), one terminal of the resistor 2222 (e.g., Rₛₙ), one terminal of the capacitor 2224 (e.g., Cₛₙ), and one terminal of the primary winding 210. Another terminal of the resistor 2222 (e.g., Rₛₙ) and another terminal of the capacitor 2224 (e.g., Cₛₙ) are connected to the cathode of the diode 2220 (e.g., Dₛₙ). Another terminal of the primary winding 210 is connected to the anode of the diode 2220 (e.g., Dₛₙ) and the drain terminal of the transistor 250 (e.g., the MOSFET MS1). Another terminal of the resistor 230 (e.g., Rₛₜ) is connected to one terminal of the capacitor 242 (e.g., Cₚ), a terminal 254 (e.g., VCC) of the pulse-width-modulation controller 252 (e.g., the controller chip U1), and the cathode of the diode 2230 (e.g., Dₚ). Another terminal of the capacitor 242 (e.g., Cₚ) is connected to one terminal of the auxiliary winding 2232 and biased to the ground voltage on the primary side. Another terminal of the auxiliary winding 2232 is connected to the anode of the diode 2230 (e.g., Dₚ).

Additionally, a terminal 256 (e.g., gate1) of the pulse-width-modulation controller 252 (e.g., the controller chip U1) is connected to the gate terminal of the transistor 250 (e.g., the MOSFET MS1). The pulse-width-modulation controller 252 (e.g., the controller chip U1) outputs a voltage 248 through the terminal 256 (e.g., gate1) to the gate terminal of the transistor 250 (e.g., the MOSFET MS1). A terminal 258 (e.g., CS) of the pulse-width-modulation controller 252 (e.g., the controller chip U1) is connected to the source terminal of the transistor 250 (e.g., the MOSFET MS1) and is also connected to one terminal of the resistor 232 (e.g., R_{cs}). Another terminal of the resistor 232 (e.g., R_{cs}) and a terminal 244 (e.g., GND) of the pulse-width-modulation controller 252 (e.g., the controller chip U1) both are biased to the ground voltage on the primary side.

One terminal of the secondary winding 212 is connected to the anode of the body diode 290, the source terminal of the transistor 280 (e.g., the MOSFET MS2), and a terminal 268 (e.g., GND) of the controller 260 for synchronous rectification (e.g., the controller chip U2). Additionally, another terminal of the secondary winding 212 is biased to the ground voltage on the secondary side. The gate terminal of the transistor 280 (e.g., the MOSFET MS2) is connected to a terminal 266 (e.g., gate2) of the controller 260 for synchronous rectification (e.g., the controller chip U2). The drain terminal of the transistor 280 (e.g., the MOSFET MS2) is connected to the cathode of the body diode 290, a terminal 262 (e.g., V_{d}) of the controller 260 for synchronous rectification (e.g., the controller chip U2), and one terminal of the capacitor 270 (e.g., Cₒᵤₜ). Another terminal of the capacitor 270 (e.g., Cₒᵤₜ) is biased to the ground voltage on the secondary side. The output voltage 272 (e.g., Vₒᵤₜ) represents the voltage drop between the two terminals of the capacitor 270 (e.g., Cₒᵤₜ). A terminal 264 (e.g., Vᵢₙ) of the controller 260 for synchronous rectification (e.g., the controller chip U2) is not biased (e.g., floating electrically). Also as shown in FIG. 2, a current 246 flows through the primary winding 210, and a current 292 (e.g., I_{sec}) flows through the secondary winding 212. The controller 260 for synchronous rectification (e.g., the controller chip U2) receives a voltage 294 through the terminal 262 (e.g., V_{d}) from the drain terminal of the transistor 280 (e.g., the MOSFET MS2), and outputs a voltage 296 through the terminal 266 (e.g., gate2) to the gate terminal of the transistor 280 (e.g., the MOSFET MS2) in order to turn on and/or turn off the transistor 280 (e.g., the MOSFET MS2).

Additionally, a terminal 2210 (e.g., gate3) of the pulse-width-modulation controller 252 (e.g., the controller chip U1) is connected to the gate terminal of the transistor 2212 (e.g., the MOSFET MS3). The drain terminal of the transistor 2212 (e.g., the MOSFET MS3) is connected to one terminal of the auxiliary winding 2214. Another terminal of the auxiliary winding 2214 is connected to one terminal of the capacitor 2216 (e.g., Cₛ), and another terminal of the capacitor 2216 (e.g., Cₛ) and the source terminal of the transistor 2212 (e.g., the MOSFET MS3) both are biased to the ground voltage on the primary side. The capacitor 2216 (e.g., Cₛ) and the transistor 2212 (e.g., the MOSFET MS3) are used to provide zero voltage switching (ZVS) on the primary side of the flyback power converter 200 through the terminal 2210 (e.g., gate3) of the pulse-width-modulation controller 252 (e.g., the controller chip U1).

For the flyback power converter 200, the controller 260 for synchronous rectification (e.g., the controller chip U2) and the transistor 280 (e.g., the MOSFET MS2) are parts of a synchronous rectification system (e.g., a synchronous rectifier). The synchronous rectification system replaces a Schottky diode in order to raise power efficiency (e.g., reducing heat generation) and improve current generation capability. Such synchronous rectification system often is used in a system with a large output current.

FIG. 3 is a simplified diagram showing a conventional controller 360 for synchronous rectification. The controller 360 for synchronous rectification includes a terminal 362 (e.g., V_{d}), a terminal 364 (e.g., Vᵢₙ), a terminal 366 (e.g., gate2), and a terminal 368 (e.g., GND). As shown in FIG. 3, the controller 360 for synchronous rectification also includes a low-dropout regulator 310, a reference signal generator 320, a switch 330 (e.g., a transistor), a NOR gate 344, a voltage adjustment component 350, a comparator 352, a minimum on-time controller 354, a NOR gate 374, a flip-flop 380, a driver 390, a voltage adjustment component 2370, a comparator 2372, a turn-on controller 2340, and a drive controller 2390. For example, the controller 360 for synchronous rectification is used as the controller 160 for synchronous rectification of the flyback power converter 100. As an example, the controller 360 for synchronous rectification is used as the controller 260 for synchronous rectification of the flyback power converter 200.

As shown in FIG. 3, the low-dropout regulator 310 receives an input voltage 312 through the terminal 364 and a voltage 332 through the terminal 362 and generates a supply voltage 314 (e.g., AVDD) based at least in part on the input voltage 312 and/or the voltage 332. If the terminal 364 is not biased (e.g., floating electrically), the low-dropout regulator 310 generates the supply voltage 314 (e.g., AVDD) based at least in part on the voltage 332. The supply voltage 314 is received by the reference signal generator 320, which in response generates one or more predetermined reference voltages (e.g., V_{ref}) and/or one or more predetermined reference currents (e.g., I_{ref}). Additionally, the supply voltage 314 is also received by the gate terminal of the transistor 330 (e.g., a high-voltage transistor). The drain terminal of the transistor 330 receives the voltage 332 through the terminal 362, and the source terminal of the transistor 330 is biased at a voltage 334. If the transistor 330 is turned on by the supply voltage 314, the voltage 334 is equal to the voltage 332. The voltage 334 is received by the voltage adjustment component 350 and the voltage adjustment component 2370.

The voltage adjustment component 350 receives the voltage 334 and generates a voltage 351 based at least in part on the voltage 334. The voltage 351 is equal to the voltage 334 minus a predetermined threshold voltage (e.g., Vₜ (on)), and the predetermined threshold voltage (e.g., Vₜ (on)) is negative. Hence, if the transistor 330 is turned on,

$${V}_{351} = {V}_{332} - {V}_{t} ( on ) \qquad ( Equation 1 )$$

where V₃₅₁ represents the voltage 351, and V₃₃₂ represents the voltage 332. Additionally, Vₜ (on) represents the predetermined threshold voltage, which has a negative value.

As shown in FIG. 3, the voltage 351 is received by the non-inverting input terminal (e.g., the “+” input terminal) of the comparator 352, which also includes an inverting input terminal (e.g., the “−” input terminal). The inverting input terminal of the comparator 352 is biased to the ground voltage (e.g., the ground voltage on the secondary side). Based at least in part on the voltage 351 received by the non-inverting input terminal and the ground voltage received by the inverting input terminal, the comparator 352 generates a signal 353. The signal 353 is at a logic high level if the voltage 351 is higher than the ground voltage, and the signal 353 is at a logic low level if the voltage 351 is lower than the ground voltage. Referring to Equation 1, when the transistor 330 is turned on, if the voltage 332 is larger than the predetermined threshold voltage (e.g., Vₜ (on)), the signal 353 (e.g., on det) is at the logic high level, and if the voltage 332 is smaller than the predetermined threshold voltage (e.g., Vₜ (on)), the signal 353 (e.g., on det) is at the logic low level. The signal 353 (e.g., on det) is received by the NOR gate 344.

The voltage adjustment component 2370 receives the voltage 334 and generates a voltage 2371 based at least in part on the voltage 334. The voltage 2371 is equal to the voltage 334 minus a predetermined threshold voltage (e.g., Vₜ (off)), and the predetermined threshold voltage (e.g., Vₜ (off)) is negative, positive, or equal to zero. Hence, if the transistor 330 is turned on,

$${V}_{2371} = {V}_{332} - {V}_{t} ( off ) \qquad ( Equation 2 )$$

where V₂₃₇₁ represents the voltage 2371, and V₃₃₂ represents the voltage 332. Additionally, Vₜ (off) represents the predetermined threshold voltage, which has a negative value, a zero value, or a positive value.

As shown in FIG. 3, the voltage 2371 is received by an inverting input terminal (e.g., the “−” input terminal) of the comparator 2372, which also includes a non-inverting input terminal (e.g., the “+” input terminal). The non-inverting input terminal of the comparator 2372 is biased to the ground voltage (e.g., the ground voltage on the secondary side). Based at least in part on the voltage 2371 received by the inverting input terminal and the ground voltage received by the non-inverting input terminal, the comparator 2372 generates a signal 372. The signal 372 is at a logic high level if the voltage 2371 is lower than the ground voltage, and the signal 372 is at a logic low level if the voltage 2371 is higher than the ground voltage. The signal 372 is received by the NOR gate 374.

A signal 382 is received by the minimum on-time controller 354, which in response, generates a signal 355 based at least in part on the signal 382. If the signal 382 changes from the logic low level to the logic high level when the signal 355 is at the logic low level, the signal 355 changes from the logic low level to the logic high level. After the signal 355 changes from the logic low level to the logic high level, the signal 355 remains at the logic high level for at least a predetermined minimum turn-on time duration (e.g., T_{on_min}). During the predetermined minimum turn-on time duration (e.g., T_{on_min}), the signal 355 remains at the logic high level, even if the signal 382 changes from the logic high level to the logic low level. The signal 355 is received by the NOR gate 374, which also receives the signal 372 and generates a signal 376 based at least in part on the signal 355 and the signal 372.

The turn-on controller 2340 receives the signal 382 and the voltage 332 and generates a signal 342 based at least in part on the signal 382 and the voltage 332. The signal 342 is received by the NOR gate 344, which also receives the signal 353 and generates a signal 346 based at least in part on the signal 342 and the signal 353.

As shown in FIG. 3, the signal 346 and the signal 376 are received by the flip-flop 380, which in response generates the signal 382 (e.g., sr) based at least in part on the signal 346 and the signal 376. The flip-flop 380 includes an R terminal, an S terminal, and a QN terminal. The R terminal receives the signal 346, the S terminal receives the signal 376, and the QN terminal outputs the signal 382 (e.g., sr). The signal 382 (e.g., sr) is received by the driver 390.

Additionally, the drive controller 2390 receives the signal 382 and the voltage 334 and generates a signal 2391 based at least in part on the signal 382 and the voltage 334. The driver 390 receives the signal 2391 and the signal 382 (e.g., sr), generates a voltage 392 (e.g., a drive voltage) based at least in part on the signal 2391 and the signal 382 (e.g., sr), and sends out the voltage 392 through the terminal 366. For example, if the signal 382 (e.g., sr) is at a logic high level, the voltage 392 (e.g., a drive voltage) is at the logic high level. As an example, if the signal 382 (e.g., sr) is at a logic low level, the voltage 392 (e.g., a drive voltage) is at the logic low level. In some examples, the signal 2391 is used to control the generation of the voltage 392 (e.g., a drive voltage) when the flyback power converter 100 and/or the flyback power converter 200 operates in a burst mode. As an example, the burst mode is a specific state of a discontinuous conduction mode (DCM).

In some examples, the controller 360 for synchronous rectification is a part of the flyback power converter 100, and the controller 360 for synchronous rectification is the same as the controller 160 for synchronous rectification. The terminal 362 is the same as the terminal 162, the terminal 364 is the same as the terminal 164, the terminal 366 is the same as the terminal 166, and the terminal 368 is the same as the terminal 168. Additionally, the voltage 332 is the same as the voltage 194, and the voltage 392 is the same as the voltage 196.

In certain examples, the controller 360 for synchronous rectification is a part of the flyback power converter 200, and the controller 360 for synchronous rectification is the same as the controller 260 for synchronous rectification. The terminal 362 is the same as the terminal 262, the terminal 364 is the same as the terminal 264, the terminal 366 is the same as the terminal 266, and the terminal 368 is the same as the terminal 268. Additionally, the voltage 332 is the same as the voltage 294, and the voltage 392 is the same as the voltage 296.

Usually, the flyback power converter 100 can operate in different modes depending on the input voltage, the output voltage, and/or the output current of the flyback power converter 100, and the flyback power converter 200 can also operate in different modes depending on the input voltage, the output voltage, and/or the output current of the flyback power converter 200. These different modes include discontinuous conduction mode (DCM), quasi resonant (QR) mode, and continuous conduction mode (CCM).

FIG. 4 shows simplified conventional timing diagrams in discontinuous conduction mode (DCM) related to the controller 360 for synchronous rectification as shown in FIG. 3 as part of the flyback power converter 100 as shown in FIG. 1 and/or as part of the flyback power converter 200 as shown in FIG. 2. For example, the waveform 448 represents the voltage 148 as a function of time, the waveform 462 represents a voltage difference from the drain terminal to the source terminal of the transistor 180 as a function of time, the waveform 492 represents the voltage 196, which is equal to the voltage 392, as a function of time, and the waveform 455 represents the signal 355 as a function of time. As an example, the waveform 448 represents the voltage 248 as a function of time, the waveform 462 represents a voltage difference from the drain terminal to the source terminal of the transistor 280 as a function of time, the waveform 492 represents the voltage 296, which is equal to the voltage 392, as a function of time, and the waveform 455 represents the signal 355 as a function of time.

In some examples, T_{on_min} represents the predetermined minimum turn-on time duration related to the minimum on-time controller 354. In certain examples, Vₜ (slp) represents a reference voltage (e.g., equal to 2 V), Vₜ (on) represents the predetermined threshold voltage (e.g., equal to −200 mV) related to the voltage adjustment component 350, Vₜ (off) represents the predetermined threshold voltage (e.g., equal to 0 mV) related to the voltage adjustment component 2370. In some examples, Tₛ represents a time duration for the voltage difference from the drain terminal to the source terminal of the transistor 180 and/or the transistor 280 to decrease from Vₜ (slp) to Vₜ (on). In certain examples, Vₒᵤₜ represents the output voltage 172 and/or the output voltage 272. For example, Vₒᵤₜ ranges from 3 V to 21 V. As an example, if Tₛ is smaller than a predetermined reference time duration (e.g., T_{ref}), the turn-on controller 2340 generates the signal 342 at a logic low level, and if the voltage difference from the drain terminal to the source terminal of the transistor 180 and/or the transistor 280 is smaller than Vₜ (on), the comparator 352 generates the signal 353 at the logic low level, causing the NOR gate 344 to generate the signal 346 at a logic high level.

Hence it is highly desirable to improve the techniques related to synchronous rectification in power converters with zero voltage switching.

### 3. BRIEF SUMMARY OF THE INVENTION

Certain embodiments of the present invention are directed to circuits. More particularly, some embodiments of the invention provide systems and methods for controlling synchronous rectifiers. Merely by way of example, some embodiments of the invention have been applied to flyback power converters with zero voltage switching. But it would be recognized that the invention has a much broader range of applicability.

According to certain embodiments, a system for controlling synchronous rectification includes: a first control-signal generator configured to generate a first control signal; a second control-signal generator configured to receive the first control signal for a first switching cycle and generate a second control signal for a second switching cycle based at least in part on the first control signal for the first switching cycle, the first switching cycle preceding the second switching cycle; and a driver configured to receive the first control signal and generate a drive voltage based at least in part on the first control signal; wherein the second control-signal generator is further configured to: process information associated with the first control signal; determine a first time duration when the first control signal remains at a first logic level during the first switching cycle; determine a second time duration based at least in part on the first time duration; and generate the second control signal representing the second time duration for the second switching cycle; wherein the first control-signal generator configured to, during the second switching cycle, keep the first control signal at the first logic level for at least the second time duration.

According to some embodiments, a system for controlling synchronous rectification includes: a first terminal configured to receive a first voltage; a second terminal configured to receive a second voltage, a voltage difference being equal to the second voltage minus the first voltage, the voltage difference as a function of time being represented by a voltage-difference waveform; a third terminal configured to output a drive voltage; a control-signal generator configured to process information associated with the voltage difference and generate a control signal based on at least information associated with the voltage difference; and a driver configured to process information associated with the control signal and generate the drive voltage based at least in part on the control signal; wherein the control-signal generator is further configured to: detect a first peak of the voltage difference; determine a reference voltage based on at least information associated with the first peak; determine a first actual area corresponding to the first peak under the voltage-difference waveform above the reference voltage; and determine a reference area based at least in part on the first actual area; wherein the control-signal generator is further configured to: determine a second actual area corresponding to a second peak under the voltage-difference waveform above the reference voltage, the second peak following the first peak; and process information associated with the second actual area and the reference area; wherein the control-signal generator is further configured to, if the second actual area is smaller than the reference area, generate the control signal at a first logic level; and not allow the drive voltage to change from a second logic level to a third logic level.

According to certain embodiments, a system for controlling synchronous rectification includes: a first terminal configured to receive a first voltage; a second terminal configured to receive a second voltage, a voltage difference being equal to the second voltage minus the first voltage; a third terminal configured to output a drive voltage; a control-signal generator configured to process information associated with the voltage difference and generate a control signal based on at least information associated with the voltage difference; and a driver configured to process information associated with the control signal and generate the drive voltage based at least in part on the control signal; wherein the control-signal generator is further configured to: detect a first peak of the voltage difference; determine a reference voltage based on at least information associated with the first peak; detect a second peak of the voltage difference, the second peak following the first peak; and process information associated with the second peak and the reference voltage; wherein the control-signal generator is further configured to, if a magnitude of the second peak is smaller than the reference voltage, generate the control signal at a first logic level; and not allow the drive voltage to change from a second logic level to a third logic level; wherein the control-signal generator is further configured to, if the magnitude of the second peak is larger than the reference voltage, determine a time duration for the voltage difference to decrease from the reference voltage to a threshold voltage; and if the time duration is larger than a predetermined duration, generate the control signal at the first logic level; and not allow the drive voltage to change from the second logic level to the third logic level.

According to some embodiments, a method for controlling synchronous rectification includes: generating a first control signal; receiving the first control signal for a first switching cycle; generating a second control signal for a second switching cycle based at least in part on the first control signal for the first switching cycle, the first switching cycle preceding the second switching cycle; and generating a drive voltage based at least in part on the first control signal; wherein the generating a second control signal for a second switching cycle includes: processing information associated with the first control signal; determining a first time duration when the first control signal remains at a first logic level during the first switching cycle; determining a second time duration based at least in part on the first time duration; and generating the second control signal representing the second time duration for the second switching cycle; wherein the generating a first control signal includes, during the second switching cycle, keeping the first control signal at the first logic level for at least the second time duration.

According to certain embodiments, a method for controlling synchronous rectification includes: receiving a first voltage; receiving a second voltage, a voltage difference being equal to the second voltage minus the first voltage, the voltage difference as a function of time being represented by a voltage-difference waveform; outputting a drive voltage; processing information associated with the voltage difference; generating a control signal based on at least information associated with the voltage difference; processing information associated with the control signal; and generating the drive voltage based at least in part on the control signal; wherein the processing information associated with the voltage difference includes: detecting a first peak of the voltage difference; determining a reference voltage based on at least information associated with the first peak; determining a first actual area corresponding to the first peak under the voltage-difference waveform above the reference voltage; and determining a reference area based at least in part on the first actual area; wherein the processing information associated with the voltage difference further includes: determining a second actual area corresponding to a second peak under the voltage-difference waveform above the reference voltage, the second peak following the first peak; and processing information associated with the second actual area and the reference area; wherein the generating a control signal based on at least information associated with the voltage difference includes, if the second actual area is smaller than the reference area, generating the control signal at a first logic level; and not allowing the drive voltage to change from a second logic level to a third logic level.

According to some embodiments, a method for controlling synchronous rectification includes: receiving a first voltage; receiving a second voltage, a voltage difference being equal to the second voltage minus the first voltage; outputting a drive voltage; processing information associated with the voltage difference; generating a control signal based on at least information associated with the voltage difference; processing information associated with the control signal; and generating the drive voltage based at least in part on the control signal; wherein the processing information associated with the voltage difference includes: detecting a first peak of the voltage difference; determining a reference voltage based on at least information associated with the first peak; detecting a second peak of the voltage difference, the second peak following the first peak; and processing information associated with the second peak and the reference voltage; wherein the generating a control signal based on at least information associated with the voltage difference includes, if a magnitude of the second peak is smaller than the reference voltage, generating the control signal at a first logic level; and not allowing the drive voltage to change from a second logic level to a third logic level; wherein the generating a control signal based on at least information associated with the voltage difference further includes, if the magnitude of the second peak is larger than the reference voltage, determining a time duration for the voltage difference to decrease from the reference voltage to a threshold voltage; and if the time duration is larger than a predetermined duration, generating the control signal at the first logic level; and not allowing the drive voltage to change from the second logic level to the third logic level.

Depending upon embodiment, one or more benefits may be achieved. These benefits and various additional objects, features and advantages of the present invention can be fully appreciated with reference to the detailed description and accompanying drawings that follow.

### 4. BRIEF DESCRIPTION OF THE DRAWINGS

FIG. 1 is a simplified diagram showing a conventional flyback power converter with zero voltage switching and synchronous rectification.

FIG. 2 is a simplified diagram showing another conventional flyback power converter with zero voltage switching and synchronous rectification.

FIG. 3 is a simplified diagram showing a conventional controller for synchronous rectification.

FIG. 4 shows simplified conventional timing diagrams in discontinuous conduction mode (DCM) related to the controller for synchronous rectification as shown in FIG. 3 as part of the flyback power converter as shown in FIG. 1 and/or as part of the flyback power converter as shown in FIG. 2.

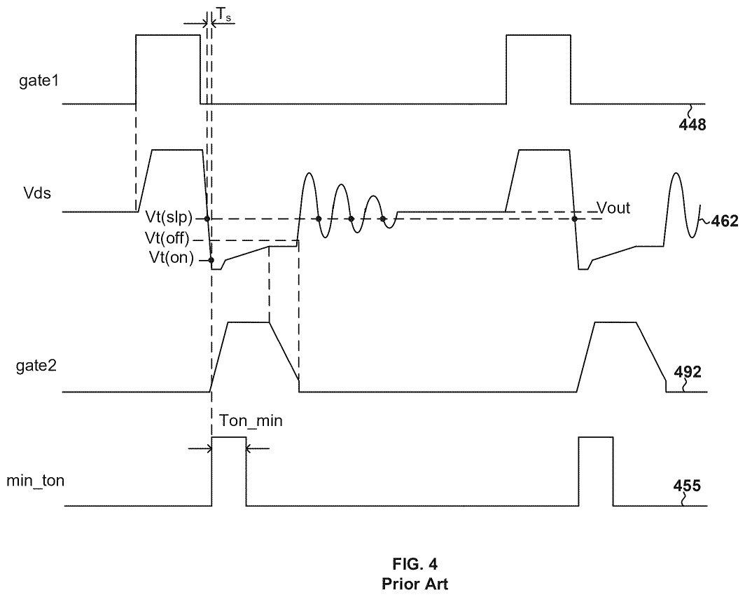

FIG. 5 shows simplified timing diagrams with one or more voltage spikes in discontinuous conduction mode (DCM) related to the controller for synchronous rectification as shown in FIG. 3 as part of the flyback power converter as shown in FIG. 1 and/or as part of the flyback power converter as shown in FIG. 2 according to some embodiments.

FIG. 6 is a simplified diagram showing a flyback power converter with zero voltage switching and synchronous rectification according to certain embodiments of the present invention.

FIG. 7 is a simplified diagram showing a flyback power converter with zero voltage switching and synchronous rectification according to some embodiments of the present invention.

FIG. 8 is a simplified diagram showing a controller for synchronous rectification according to certain embodiments of the present invention.

FIG. 9 is a simplified diagram showing the turn-on controller as part of the controller for synchronous rectification as shown in FIG. 8 according to some embodiments of the present invention.

FIG. 10 shows simplified timing diagrams related to the adaptive minimum off-time controller and the adaptive voltage slope detector as shown in FIG. 9 of the controller for synchronous rectification as shown in FIG. 8 as part of the flyback power converter as shown in FIG. 6 and/or as part of the flyback power converter as shown in FIG. 7 according to certain embodiments of the present invention.

FIG. 11 shows simplified timing diagrams related to the adaptive area detector as shown in FIG. 9 of the controller for synchronous rectification as shown in FIG. 8 as part of the flyback power converter as shown in FIG. 6 and/or as part of the flyback power converter as shown in FIG. 7 according to some embodiments of the present invention.

FIG. 12 is a simplified diagram showing the adaptive voltage slope detector as shown in FIG. 9 of the controller for synchronous rectification as shown in FIG. 8 as part of the flyback power converter as shown in FIG. 6 and/or as part of the flyback power converter as shown in FIG. 7 according to certain embodiments of the present invention.

FIG. 13 is a simplified diagram showing the adaptive minimum off-time controller as shown in FIG. 9 of the controller for synchronous rectification as shown in FIG. 8 as part of the flyback power converter as shown in FIG. 6 and/or as part of the flyback power converter as shown in FIG. 7 according to certain embodiments of the present invention.

FIG. 14 is a simplified diagram showing the adaptive area detector as shown in FIG. 9 of the controller for synchronous rectification as shown in FIG. 8 as part of the flyback power converter as shown in FIG. 6 and/or as part of the flyback power converter as shown in FIG. 7 according to certain embodiments of the present invention.

### 5. DETAILED DESCRIPTION OF THE INVENTION

Certain embodiments of the present invention are directed to circuits. More particularly, some embodiments of the invention provide systems and methods for controlling synchronous rectifiers. Merely by way of example, some embodiments of the invention have been applied to flyback power converters with zero voltage switching. But it would be recognized that the invention has a much broader range of applicability.

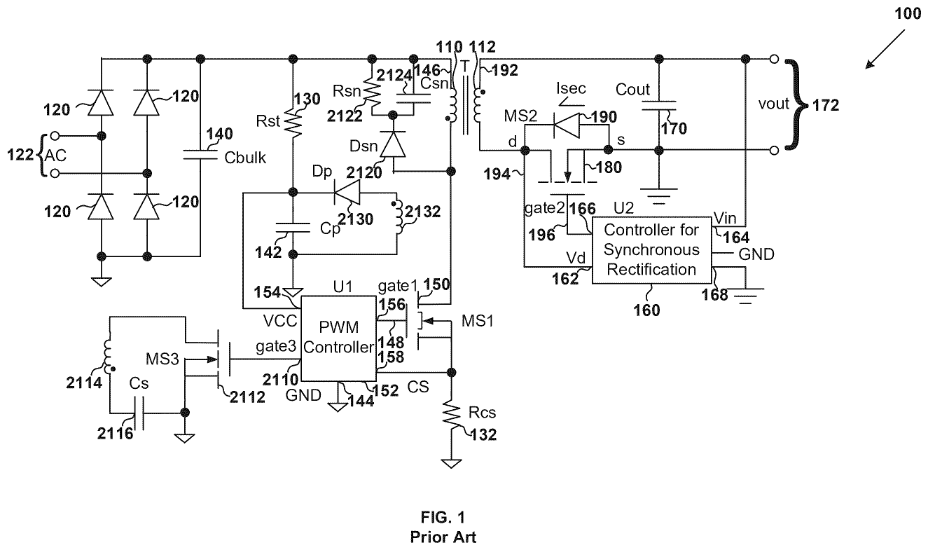

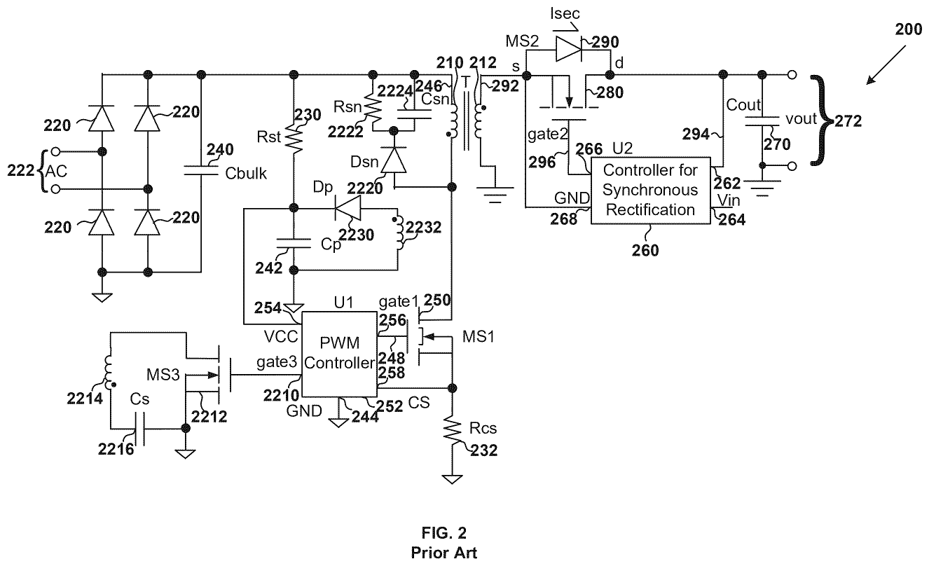

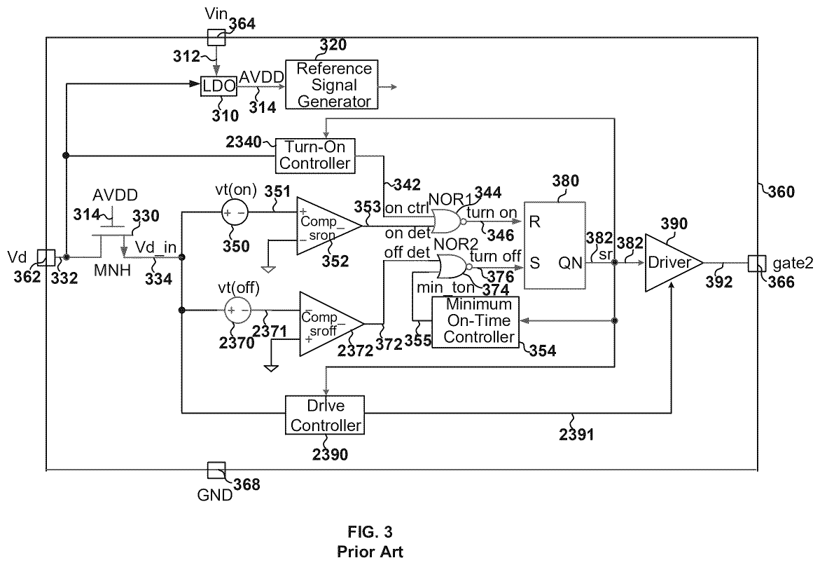

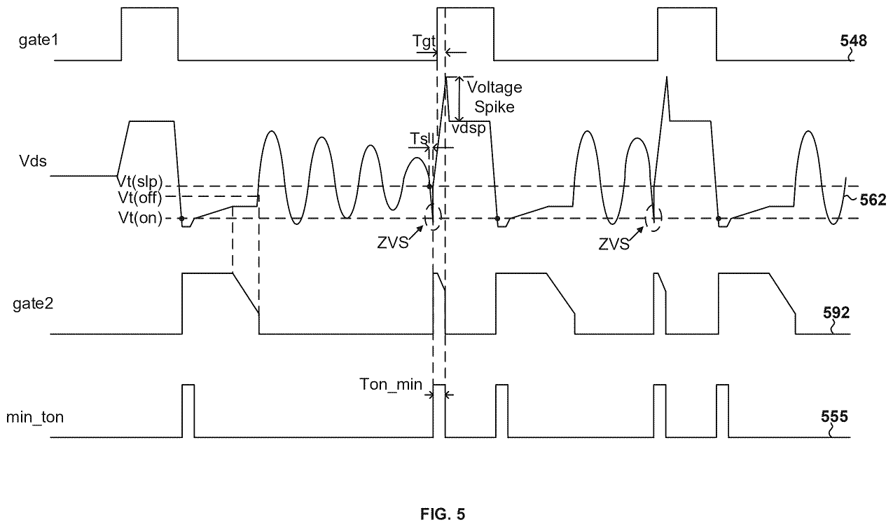

FIG. 5 shows simplified timing diagrams with one or more voltage spikes in discontinuous conduction mode (DCM) related to the controller 360 for synchronous rectification as shown in FIG. 3 as part of the flyback power converter 100 as shown in FIG. 1 and/or as part of the flyback power converter 200 as shown in FIG. 2 according to some embodiments. For example, the waveform 548 represents the voltage 148 as a function of time, the waveform 562 represents a voltage difference from the drain terminal to the source terminal of the transistor 180 as a function of time, the waveform 592 represents the voltage 196, which is equal to the voltage 392, as a function of time, and the waveform 555 represents the signal 355 as a function of time. As an example, the waveform 548 represents the voltage 248 as a function of time, the waveform 562 represents a voltage difference from the drain terminal to the source terminal of the transistor 280 as a function of time, the waveform 592 represents the voltage 296, which is equal to the voltage 392, as a function of time, and the waveform 555 represents the signal 355 as a function of time.

In some examples, T_{on_min} represents the predetermined minimum turn-on time duration related to the minimum on-time controller 354. In certain examples, Vₜ (slp) represents a reference voltage (e.g., equal to 2 V), Vₜ (on) represents the predetermined threshold voltage (e.g., equal to −200 mV) related to the voltage adjustment component 350, Vₜ (off) represents the predetermined threshold voltage (e.g., equal to 0 mV) related to the voltage adjustment component 2370. In some examples, Tₛ represents a time duration for the voltage difference from the drain terminal to the source terminal of the transistor 180 and/or the transistor 280 to decrease from Vₜ (slp) to Vₜ (on). In certain examples, if Tₛ is smaller than a predetermined reference time duration (e.g., T_{ref}), the turn-on controller 2340 generates the signal 342 at a logic low level, and if the voltage difference from the drain terminal to the source terminal of the transistor 180 and/or the transistor 280 is smaller than Vₜ (on), the comparator 352 generates the signal 353 at the logic low level, causing the NOR gate 344 to generate the signal 346 at a logic high level.

According to certain embodiments, the flyback power converter 100 uses the zero voltage switching (ZVS) mechanism on the primary side of the flyback power converter 100, and/or the flyback power converter 200 uses the zero voltage switching (ZVS) mechanism on the primary side of the flyback power converter 200. In some examples, as shown by the waveform 562, during oscillation, the falling edge of the voltage difference from the drain terminal to the source terminal of the transistor 180 and/or the transistor 280 is steep, so that Tₛ is smaller than the predetermined reference time duration (e.g., T_{ref}) and the voltage difference from the drain terminal to the source terminal of the transistor 180 and/or the transistor 280 also becomes smaller than Vₜ (on). For example, as shown by the waveform 592, the voltage 392 changes from a logic low level to a logic high level, and the transistor 180 and/or the transistor 280 becomes turned on during oscillation. As an example, after the transistor 180 and/or the transistor 280 becomes turned on, the transistor 180 and/or the transistor 280 remains turned on for at least T_{on_min}.

In certain examples, during T_{on_min}, if the transistor 150 and/or the transistor 250 also becomes turned on, the transistor 150 and the transistor 180 are turned on simultaneously, and/or the transistor 250 and the transistor 280 are turned on simultaneously. For example, when the transistor 150 and the transistor 180 are turned on simultaneously, the voltage difference from the drain terminal to the source terminal of the transistor 180 experiences one or more voltage spikes as shown by the waveform 562. As an example, when the transistor 250 and the transistor 280 are turned on simultaneously, the voltage difference from the drain terminal to the source terminal of the transistor 280 experiences one or more voltage spikes as shown by the waveform 562.

According to some embodiments, one or more voltage spikes for the voltage difference from the drain terminal to the source terminal of the transistor 180 and/or the transistor 280 cause damage to the transistor 180 and/or the transistor 280 respectively. According to certain embodiments, the flyback power converter 100 and/or the flyback power converter 200 uses a constant value for Vₜ (slp). For example, with the constant value for Vₜ (slp), it is difficult to select the predetermined reference time duration (e.g., T_{ref}) that is suitable for various alternating current (AC) input voltages and/or various output voltages.

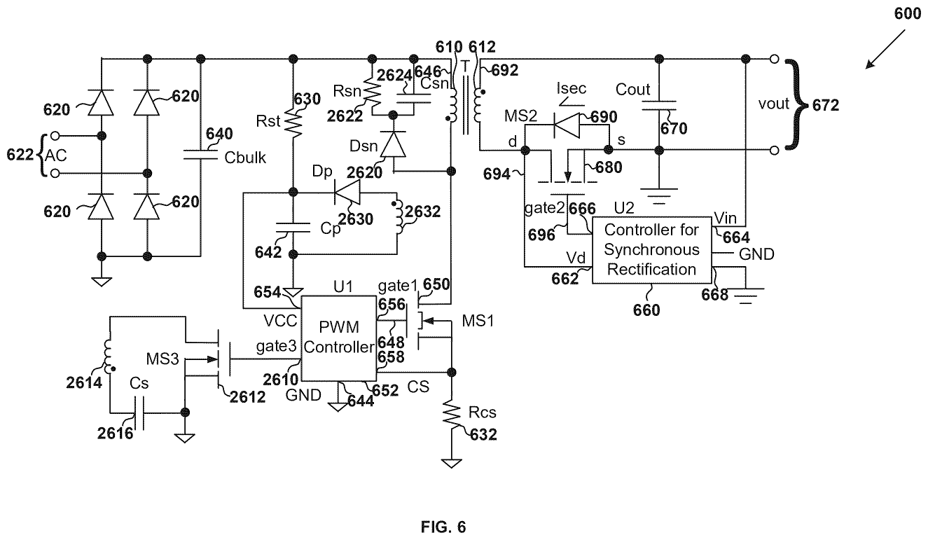

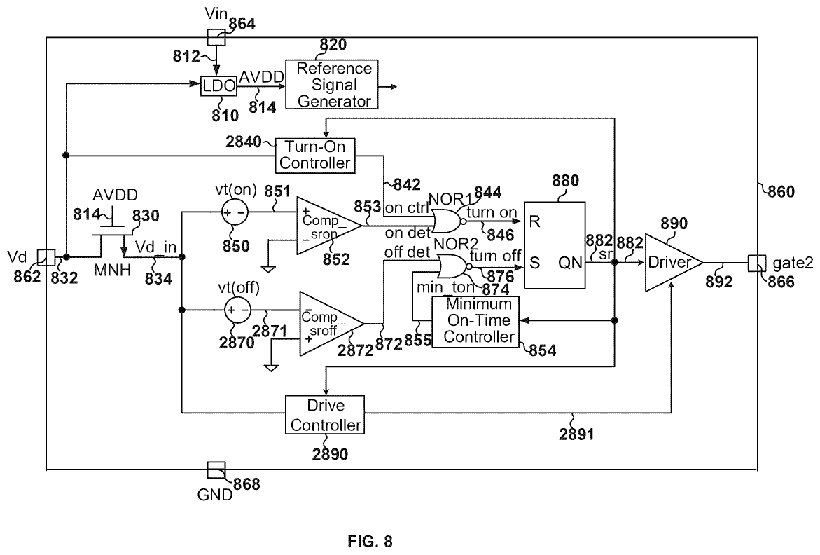

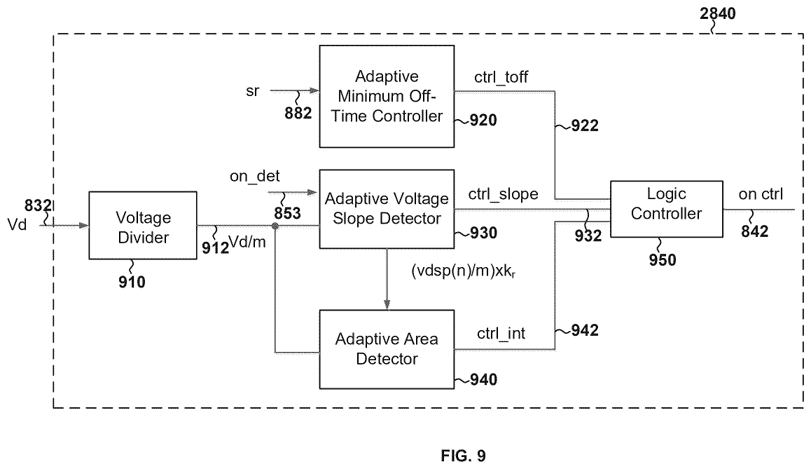

FIG. 6 is a simplified diagram showing a flyback power converter with zero voltage switching and synchronous rectification according to certain embodiments of the present invention. This diagram is merely an example, which should not unduly limit the scope of the claims. One of ordinary skill in the art would recognize many variations, alternatives, and modifications. The flyback power converter 600 includes a primary winding 610 and a secondary winding 612, which are parts of a transformer (e.g., a transformer T). For example, the transformer (e.g., a transformer T) includes the primary winding 610, the secondary winding 612, and auxiliary windings 2614 and 2632. In some examples, on the primary side, the flyback power converter 600 also includes a bridge rectifier 620 (e.g., a rectifier that includes four diodes), a resistor 630 (e.g., Rₛₜ), a resistor 632 (e.g., R_{cs}), a capacitor 640 (e.g., C_{bulk}), a capacitor 642 (e.g., Cₚ), a transistor 650 (e.g., a power MOSFET MS1), a pulse-width-modulation controller 652 (e.g., a controller chip U1), a transistor 2612 (e.g., the MOSFET MS3), a capacitor 2616 (e.g., Cₛ), a diode 2620 (e.g., Dₛₙ), a resistor 2622 (e.g., Rₛₙ), a capacitor 2624 (e.g., Cₛₙ), and a diode 2630 (e.g., Dₚ). In certain examples, on the secondary side, the flyback power converter 600 also includes a controller 660 for synchronous rectification (e.g., a controller chip U2), a capacitor 670 (e.g., Cₒᵤₜ), a transistor 680 (e.g., a MOSFET MS2), and a body diode 690 (e.g., a parasitic diode of the transistor 680). For example, the controller 660 for synchronous rectification includes a turn-on controller (e.g., the turn-on controller 2840 as shown in FIG. 8) that includes the adaptive minimum off-time controller (e.g., the adaptive minimum off-time controller 920 as shown in FIG. 9), the adaptive voltage slope detector (e.g., the adaptive voltage slope detector 930 as shown in FIG. 9), and/or the adaptive area detector (e.g., the adaptive area detector 940 as shown in FIG. 9). As an example, the controller 660 for synchronous rectification (e.g., a controller chip U2) and the transistor 680 (e.g., a MOSFET MS2) are parts of a synchronous rectifier.

As shown in FIG. 6, an alternating current (AC) input voltage 622 is rectified by the bridge rectifier 620 and then filtered by the capacitor 640 (e.g., C_{bulk}) according to some embodiments. For example, one terminal of the capacitor 640 (e.g., C_{bulk}) is connected to one terminal of the resistor 630 (e.g., Rₛₜ), one terminal of the resistor 2622 (e.g., Rₛₙ), one terminal of the capacitor 2624 (e.g., Cₛₙ), and one terminal of the primary winding 610. As an example, another terminal of the resistor 2622 (e.g., Rₛₙ) and another terminal of the capacitor 2624 (e.g., Cₛₙ) are connected to the cathode of the diode 2620 (e.g., Dₛₙ). For example, another terminal of the primary winding 610 is connected to the anode of the diode 2620 (e.g., Dₛₙ) and the drain terminal of the transistor 650 (e.g., the MOSFET MS1). As an example, another terminal of the resistor 630 (e.g., Rₛₜ) is connected to one terminal of the capacitor 642 (e.g., Cₚ), a terminal 654 (e.g., VCC) of the pulse-width-modulation controller 652 (e.g., the controller chip U1), and the cathode of the diode 2630 (e.g., Dₚ). For example, another terminal of the capacitor 642 (e.g., Cₚ) is connected to one terminal of the auxiliary winding 2632 and biased to the ground voltage on the primary side. As an example, another terminal of the auxiliary winding 2632 is connected to the anode of the diode 2630 (e.g., Dₚ).

In certain embodiments, a terminal 656 (e.g., gate1) of the pulse-width-modulation controller 652 (e.g., the controller chip U1) is connected to the gate terminal of the transistor 650 (e.g., the MOSFET MS1). For example, the pulse-width-modulation controller 652 (e.g., the controller chip U1) outputs a voltage 648 through the terminal 656 (e.g., gate1) to the gate terminal of the transistor 650 (e.g., the MOSFET MS1). As an example, a terminal 658 (e.g., CS) of the pulse-width-modulation controller 652 (e.g., the controller chip U1) is connected to the source terminal of the transistor 650 (e.g., the MOSFET MS1) and is also connected to one terminal of the resistor 632 (e.g., R_{cs}). Another terminal of the resistor 632 (e.g., R_{cs}) and a terminal 644 (e.g., GND) of the pulse-width-modulation controller 652 (e.g., the controller chip U1) both are biased to the ground voltage on the primary side.

In some embodiments, one terminal of the secondary winding 612 is connected to the cathode of the body diode 690, the drain terminal of the transistor 680 (e.g., the MOSFET MS2), and a terminal 662 (e.g., V_{d}) of the controller 660 for synchronous rectification (e.g., the controller chip U2). For example, another terminal of the secondary winding 612 is connected to one terminal of the capacitor 670 (e.g., Cₒᵤₜ) and is also connected to a terminal 664 (e.g., Vᵢₙ) of the controller 660 for synchronous rectification (e.g., the controller chip U2). As an example, the source terminal of the transistor 680 (e.g., the MOSFET MS2) is connected to the anode of the body diode 690, and the gate terminal of the transistor 680 (e.g., the MOSFET MS2) is connected to a terminal 666 (e.g., gate2) of the controller 660 for synchronous rectification (e.g., the controller chip U2). For example, another terminal of the capacitor 670 (e.g., Cₒᵤₜ), the source terminal of the transistor 680 (e.g., the MOSFET MS2), and a terminal 668 (e.g., GND) of the controller 660 for synchronous rectification (e.g., the controller chip U2) all are biased to the ground voltage on the secondary side. As an example, the output voltage 672 (e.g., Vₒᵤₜ) represents the voltage drop between the two terminals of the capacitor 670 (e.g., Cₒᵤₜ). In certain examples, as shown in FIG. 6, a current 646 flows through the primary winding 610, and a current 692 (e.g., I_{sec}) flows through the secondary winding 612. For example, the controller 660 for synchronous rectification (e.g., the controller chip U2) receives a voltage 694 through the terminal 662 (e.g., V_{d}) from the drain terminal of the transistor 680 (e.g., the MOSFET MS2), and outputs a voltage 696 through the terminal 666 (e.g., gate2) to the gate terminal of the transistor 680 (e.g., the MOSFET MS2) in order to turn on and/or turn off the transistor 680 (e.g., the MOSFET MS2).

According to certain embodiments, a terminal 2610 (e.g., gate3) of the pulse-width-modulation controller 652 (e.g., the controller chip U1) is connected to the gate terminal of the transistor 2612 (e.g., the MOSFET MS3). For example, the drain terminal of the transistor 2612 (e.g., the MOSFET MS3) is connected to one terminal of the auxiliary winding 2614. As an example, another terminal of the auxiliary winding 2614 is connected to one terminal of the capacitor 2616 (e.g., Cₛ), and another terminal of the capacitor 2616 (e.g., Cₛ) and the source terminal of the transistor 2612 (e.g., the MOSFET MS3) both are biased to the ground voltage on the primary side. For example, the capacitor 2616 (e.g., Cₛ) and the transistor 2612 (e.g., the MOSFET MS3) are used to provide zero voltage switching (ZVS) on the primary side of the flyback power converter 600 through the terminal 2610 (e.g., gate3) of the pulse-width-modulation controller 652 (e.g., the controller chip U1). According to some embodiments, for the flyback power converter 600, the controller 660 for synchronous rectification (e.g., the controller chip U2) and the transistor 680 (e.g., the MOSFET MS2) are parts of a synchronous rectification system (e.g., a synchronous rectifier).

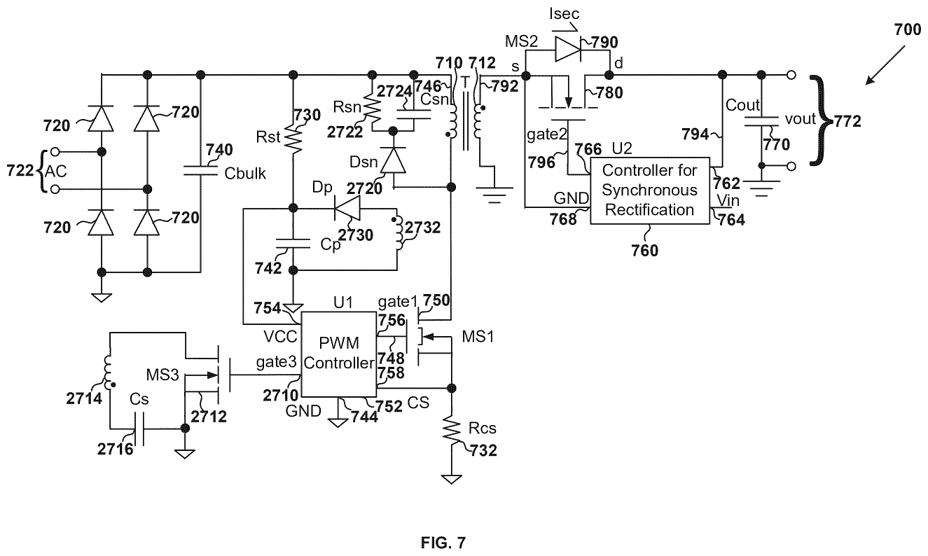

FIG. 7 is a simplified diagram showing a flyback power converter with zero voltage switching and synchronous rectification according to some embodiments of the present invention. This diagram is merely an example, which should not unduly limit the scope of the claims. One of ordinary skill in the art would recognize many variations, alternatives, and modifications. The flyback power converter 700 includes a primary winding 710 and a secondary winding 712, which are parts of a transformer (e.g., a transformer T). For example, the transformer (e.g., a transformer T) includes the primary winding 710, the secondary winding 712, and auxiliary windings 2714 and 2732. In some examples, on the primary side, the flyback power converter 700 also includes a bridge rectifier 720 (e.g., a rectifier that includes four diodes), a resistor 730 (e.g., Rₛₜ), a resistor 732 (e.g., R_{cs}), a capacitor 740 (e.g., C_{bulk}), a capacitor 742 (e.g., Cₚ), a transistor 750 (e.g., a power MOSFET MS1), a pulse-width-modulation controller 752 (e.g., a controller chip U1), a transistor 2712 (e.g., the MOSFET MS3), a capacitor 2716 (e.g., Cₛ), a diode 2720 (e.g., Dₛₙ), a resistor 2722 (e.g., Rₛₙ), a capacitor 2724 (e.g., Cₛₙ), and a diode 2730 (e.g., Dₚ). In certain examples, on the secondary side, the flyback power converter 700 also includes a controller 760 for synchronous rectification (e.g., a controller chip U2), a capacitor 770 (e.g., Cₒᵤₜ), and a transistor 780 (e.g., a MOSFET MS2), and a body diode 790 (e.g., a parasitic diode of the transistor 780). For example, the controller 760 for synchronous rectification includes a turn-on controller (e.g., the turn-on controller 2840 as shown in FIG. 8) that includes the adaptive minimum off-time controller (e.g., the adaptive minimum off-time controller 920 as shown in FIG. 9), the adaptive voltage slope detector (e.g., the adaptive voltage slope detector 930 as shown in FIG. 9), and/or the adaptive area detector (e.g., the adaptive area detector 940 as shown in FIG. 9). As an example, the controller 760 for synchronous rectification (e.g., a controller chip U2) and the transistor 780 (e.g., a MOSFET MS2) are parts of a synchronous rectifier.

As shown in FIG. 7, an alternating current (AC) input voltage 722 is rectified by the bridge rectifier 720 and then filtered by the capacitor 740 (e.g., C_{bulk}) according to certain embodiments. For example, one terminal of the capacitor 740 (e.g., C_{bulk}) is connected to one terminal of the resistor 730 (e.g., Rₛₜ), one terminal of the resistor 2722 (e.g., Rₛₙ), one terminal of the capacitor 2724 (e.g., Cₛₙ), and one terminal of the primary winding 710. As an example, another terminal of the resistor 2722 (e.g., Rₛₙ) and another terminal of the capacitor 2724 (e.g., Cₛₙ) are connected to the cathode of the diode 2720 (e.g., Dₛₙ). For example, another terminal of the primary winding 710 is connected to the anode of the diode 2720 (e.g., Dₛₙ) and the drain terminal of the transistor 750 (e.g., the MOSFET MS1). As an example, another terminal of the resistor 730 (e.g., Rₛₜ) is connected to one terminal of the capacitor 742 (e.g., Cₚ), a terminal 754 (e.g., VCC) of the pulse-width-modulation controller 752 (e.g., the controller chip U1), and the cathode of the diode 2730 (e.g., Dₚ). For example, another terminal of the capacitor 742 (e.g., Cₚ) is connected to one terminal of the auxiliary winding 2732 and biased to the ground voltage on the primary side. As an example, another terminal of the auxiliary winding 2732 is connected to the anode of the diode 2730 (e.g., Dₚ).

In some embodiments, a terminal 756 (e.g., gate1) of the pulse-width-modulation controller 752 (e.g., the controller chip U1) is connected to the gate terminal of the transistor 750 (e.g., the MOSFET MS1). For example, the pulse-width-modulation controller 752 (e.g., the controller chip U1) outputs a voltage 748 through the terminal 756 (e.g., gate1) to the gate terminal of the transistor 750 (e.g., the MOSFET MS1). As an example, a terminal 758 (e.g., CS) of the pulse-width-modulation controller 752 (e.g., the controller chip U1) is connected to the source terminal of the transistor 750 (e.g., the MOSFET MS1) and is also connected to one terminal of the resistor 732 (e.g., R_{cs}). For example, another terminal of the resistor 732 (e.g., R_{cs}) and a terminal 744 (e.g., GND) of the pulse-width-modulation controller 752 (e.g., the controller chip U1) both are biased to the ground voltage on the primary side.

In certain embodiments, one terminal of the secondary winding 712 is connected to the anode of the body diode 790, the source terminal of the transistor 780 (e.g., the MOSFET MS2), and a terminal 768 (e.g., GND) of the controller 760 for synchronous rectification (e.g., the controller chip U2). For example, another terminal of the secondary winding 712 is biased to the ground voltage on the secondary side. As an example, the gate terminal of the transistor 780 (e.g., the MOSFET MS2) is connected to a terminal 766 (e.g., gate2) of the controller 760 for synchronous rectification (e.g., the controller chip U2). For example, the drain terminal of the transistor 780 (e.g., the MOSFET MS2) is connected to the cathode of the body diode 790, a terminal 762 (e.g., V_{d}) of the controller 760 for synchronous rectification (e.g., the controller chip U2), and one terminal of the capacitor 770 (e.g., Cₒᵤₜ). As an example, another terminal of the capacitor 770 (e.g., Cₒᵤₜ) is biased to the ground voltage on the secondary side. For example, the output voltage 772 (e.g., Vₒᵤₜ) represents the voltage drop between the two terminals of the capacitor 770 (e.g., Cₒᵤₜ). As an example, a terminal 764 (e.g., Vᵢₙ) of the controller 760 for synchronous rectification (e.g., the controller chip U2) is not biased (e.g., floating electrically). In certain examples, as shown in FIG. 7, a current 746 flows through the primary winding 710, and a current 792 (e.g., I_{sec}) flows through the secondary winding 712. For example, the controller 760 for synchronous rectification (e.g., the controller chip U2) receives a voltage 794 through the terminal 762 (e.g., V_{d}) from the drain terminal of the transistor 780 (e.g., the MOSFET MS2), and outputs a voltage 796 through the terminal 766 (e.g., gate2) to the gate terminal of the transistor 780 (e.g., the MOSFET MS2) in order to turn on and/or turn off the transistor 780 (e.g., the MOSFET MS2).

According to some embodiments, a terminal 2710 (e.g., gate3) of the pulse-width-modulation controller 752 (e.g., the controller chip U1) is connected to the gate terminal of the transistor 2712 (e.g., the MOSFET MS3). For example, the drain terminal of the transistor 2712 (e.g., the MOSFET MS3) is connected to one terminal of the auxiliary winding 2714. As an example, another terminal of the auxiliary winding 2714 is connected to one terminal of the capacitor 2716 (e.g., Cₛ), and another terminal of the capacitor 2716 (e.g., Cₛ) and the source terminal of the transistor 2712 (e.g., the MOSFET MS3) both are biased to the ground voltage on the primary side. For example, the capacitor 2716 (e.g., Cₛ) and the transistor 2712 (e.g., the MOSFET MS3) are used to provide zero voltage switching (ZVS) on the primary side of the flyback power converter 700 through the terminal 2710 (e.g., gate3) of the pulse-width-modulation controller 752 (e.g., the controller chip U1). According to certain embodiments, for the flyback power converter 700, the controller 760 for synchronous rectification (e.g., the controller chip U2) and the transistor 780 (e.g., the MOSFET MS2) are parts of a synchronous rectification system (e.g., a synchronous rectifier).

FIG. 8 is a simplified diagram showing a controller 860 for synchronous rectification according to certain embodiments of the present invention. This diagram is merely an example, which should not unduly limit the scope of the claims. One of ordinary skill in the art would recognize many variations, alternatives, and modifications. The controller 860 for synchronous rectification includes a terminal 862 (e.g., V_{d}), a terminal 864 (e.g., Vᵢₙ), a terminal 866 (e.g., gate2), and a terminal 868 (e.g., GND). As shown in FIG. 8, the controller 860 for synchronous rectification also includes a low-dropout regulator 810, a reference signal generator 820, a switch 830 (e.g., a transistor), a NOR gate 844, a voltage adjustment component 850, a comparator 852, a minimum on-time controller 854, a NOR gate 874, a flip-flop 880, a driver 890, a voltage adjustment component 2870, a comparator 2872, a turn-on controller 2840, and a drive controller 2890. In some examples, the turn-on controller 2840 includes the adaptive minimum off-time controller (e.g., the adaptive minimum off-time controller 920 as shown in FIG. 9), the adaptive voltage slope detector (e.g., the adaptive voltage slope detector 930 as shown in FIG. 9), and/or the adaptive area detector (e.g., the adaptive area detector 940 as shown in FIG. 9). Although the above has been shown using a selected group of components for the controller 860 for synchronous rectification, there can be many alternatives, modifications, and variations. For example, some of the components may be expanded and/or combined. Other components may be inserted to those noted above. Depending upon the embodiment, the arrangement of components may be interchanged with others replaced. Further details of these components are found throughout the present specification.

In certain embodiments, the controller 860 for synchronous rectification is used as the controller 660 for synchronous rectification of the flyback power converter 600. For example, the terminal 862 is the terminal 662 of the controller 660 for synchronous rectification, the terminal 864 is the terminal 664 of the controller 660 for synchronous rectification, the terminal 866 is the terminal 666 of the controller 660 for synchronous rectification, and the terminal 868 is the terminal 668 of the controller 660 for synchronous rectification. In some embodiments, the controller 860 for synchronous rectification is used as the controller 760 for synchronous rectification of the flyback power converter 700. For example, the terminal 862 is the terminal 762 of the controller 660 for synchronous rectification, the terminal 864 is the terminal 764 of the controller 660 for synchronous rectification, the terminal 866 is the terminal 766 of the controller 660 for synchronous rectification, and the terminal 868 is the terminal 768 of the controller 660 for synchronous rectification.

As shown in FIG. 8, the low-dropout regulator 810 receives an input voltage 812 through the terminal 864 and a voltage 832 through the terminal 862 and generates a supply voltage 814 (e.g., AVDD) based at least in part on the input voltage 812 and/or the voltage 832 according to some embodiments. For example, if the terminal 864 is not biased (e.g., floating electrically), the low-dropout regulator 810 generates the supply voltage 814 (e.g., AVDD) based at least in part on the voltage 832. In certain examples, the supply voltage 814 is received by the reference signal generator 820, which in response generates one or more predetermined reference voltages (e.g., V_{ref}) and/or one or more predetermined reference currents (e.g., I_{ref}). In some examples, the supply voltage 814 is also received by the gate terminal of the transistor 830 (e.g., a high-voltage transistor). For example, the drain terminal of the transistor 830 receives the voltage 832 through the terminal 862, and the source terminal of the transistor 830 is biased at a voltage 834. As an example, if the transistor 830 is turned on by the supply voltage 814, the voltage 834 is equal to the voltage 832. For example, the voltage 834 is received by the voltage adjustment component 850 and the voltage adjustment component 2870.

According to certain embodiments, the voltage adjustment component 850 receives the voltage 834 and generates a voltage 851 based at least in part on the voltage 834. For example, the voltage 851 is equal to the voltage 834 minus a predetermined threshold voltage (e.g., Vₜ (on)), and the predetermined threshold voltage (e.g., Vₜ (on)) is negative. As an example, if the transistor 830 is turned on,

$${V}_{851} = {V}_{832} - {V}_{t} ( on ) \qquad ( Equation 3 )$$

where V₈₅₁ represents the voltage 851, and V₈₃₂ represents the voltage 832. Additionally, Vₜ (on) represents the predetermined threshold voltage, which has a negative value.

As shown in FIG. 8, the voltage 851 is received by the non-inverting input terminal (e.g., the “+” input terminal) of the comparator 852, which also includes an inverting input terminal (e.g., the “−” input terminal) according to some embodiments. In certain examples, the inverting input terminal of the comparator 852 is biased to the ground voltage (e.g., the ground voltage on the secondary side). For example, based at least in part on the voltage 851 received by the non-inverting input terminal and the ground voltage received by the inverting input terminal, the comparator 852 generates a signal 853. As an example, the signal 853 is at a logic high level if the voltage 851 is higher than the ground voltage, and the signal 853 is at a logic low level if the voltage 851 is lower than the ground voltage. According to certain embodiments, referring to Equation 3, when the transistor 830 is turned on, if the voltage 832 is larger than the predetermined threshold voltage (e.g., Vₜ (on)), the signal 853 (e.g., on det) is at the logic high level, and if the voltage 832 is smaller than the predetermined threshold voltage (e.g., Vₜ (on)), the signal 853 (e.g., on det) is at the logic low level. In some examples, the signal 853 (e.g., on det) is received by the NOR gate 844.

According to certain embodiments, the voltage adjustment component 2870 receives the voltage 834 and generates a voltage 2871 based at least in part on the voltage 834. For example, the voltage 2871 is equal to the voltage 834 minus a predetermined threshold voltage (e.g., Vₜ (off)), and the predetermined threshold voltage (e.g., Vₜ (off)) is negative, positive, or equal to zero. As an example, if the transistor 830 is turned on,

$${V}_{2871} = {V}_{832} - {V}_{t} ( off ) \qquad ( Equation 4 )$$

where V₂₈₇₁ represents the voltage 2871, and V₈₃₂ represents the voltage 832. Additionally, Vₜ (off) represents the predetermined threshold voltage, which has a negative value, a zero value, or a positive value.

As shown in FIG. 8, the voltage 2871 is received by an inverting input terminal (e.g., the “−” input terminal) of the comparator 2872, which also includes a non-inverting input terminal (e.g., the “+” input terminal) according to some embodiments. In certain examples, the non-inverting input terminal of the comparator 2872 is biased to the ground voltage (e.g., the ground voltage on the secondary side). For example, based at least in part on the voltage 2871 received by the inverting input terminal and the ground voltage received by the non-inverting input terminal, the comparator 2872 generates a signal 872. As an example, the signal 872 is at a logic high level if the voltage 2871 is lower than the ground voltage, and the signal 872 is at a logic low level if the voltage 2871 is higher than the ground voltage. In some examples, the signal 872 is received by the NOR gate 874.

According to certain embodiments, a signal 882 is received by the minimum on-time controller 854, which in response, generates a signal 855 based at least in part on the signal 882. In some examples, if the signal 882 changes from the logic low level to the logic high level when the signal 855 is at the logic low level, the signal 855 changes from the logic low level to the logic high level. For example, after the signal 855 changes from the logic low level to the logic high level, the signal 855 remains at the logic high level for at least a predetermined minimum turn-on time duration (e.g., T_{on_min}). As an example, during the predetermined minimum turn-on time duration (e.g., T_{on_min}), the signal 855 remains at the logic high level, even if the signal 882 changes from the logic high level to the logic low level. In certain examples, the signal 855 is received by the NOR gate 874, which also receives the signal 872 and generates a signal 876 based at least in part on the signal 855 and the signal 872.

According to some embodiments, the turn-on controller 2840 receives the signal 882 and the voltage 832 and generates a signal 842 based at least in part on the signal 882 and the voltage 832. For example, the signal 842 is received by the NOR gate 844, which also receives the signal 853 and generates a signal 846 based at least in part on the signal 842 and the signal 853. As an example, the turn-on controller 2840 includes the adaptive minimum off-time controller 920, the adaptive voltage slope detector 930, and the adaptive area detector 940 as shown in FIG. 9.

As shown in FIG. 8, the signal 846 and the signal 876 are received by the flip-flop 880, which in response generates the signal 882 (e.g., sr) based at least in part on the signal 846 and the signal 876 according to certain embodiments. In some examples, the flip-flop 880 includes an R terminal, an S terminal, and a QN terminal. For example, the R terminal receives the signal 846, the S terminal receives the signal 876, and the QN terminal outputs the signal 882 (e.g., sr). In certain examples, the signal 882 (e.g., sr) is received by the driver 890.

In some embodiments, the drive controller 2890 receives the signal 882 and the voltage 834 and generates a signal 2891 based at least in part on the signal 882 and the voltage 834. In certain embodiments, the driver 890 receives the signal 2891 and the signal 882 (e.g., sr), generates a voltage 892 (e.g., a drive voltage) based at least in part on the signal 2891 and the signal 882 (e.g., sr), and sends out the voltage 892 through the terminal 866. For example, the signal 2891 is used to control the generation of the voltage 892 (e.g., a drive voltage) when the flyback power converter 600 and/or the flyback power converter 700 operates in a burst mode. As an example, the burst mode is a specific state of a discontinuous conduction mode (DCM).

In certain examples, if the voltage 892 (e.g., a drive voltage) is at a logic high level, the transistor 680 (e.g., a MOSFET MS2) and/or the transistor 780 (e.g., a MOSFET MS2) is turned on, and if the voltage 892 (e.g., a drive voltage) is at a logic low level, the transistor 680 (e.g., a MOSFET MS2) and/or the transistor 780 (e.g., a MOSFET MS2) is turned off. For example, if the signal 882 (e.g., sr) is at the logic high level, the voltage 892 (e.g., a drive voltage) is at the logic high level. As an example, if the signal 882 (e.g., sr) is at the logic low level, the voltage 892 (e.g., a drive voltage) is at the logic low level.

As discussed above and further emphasized here, FIG. 8 is merely an example, which should not unduly limit the scope of the claims. One of ordinary skill in the art would recognize many variations, alternatives, and modifications. For example, the signal 853 (e.g., on det) is also received by the turn-on controller 2840.

FIG. 9 is a simplified diagram showing the turn-on controller 2840 as part of the controller 860 for synchronous rectification as shown in FIG. 8 according to some embodiments of the present invention. This diagram is merely an example, which should not unduly limit the scope of the claims. One of ordinary skill in the art would recognize many variations, alternatives, and modifications. The turn-on controller 2840 includes a voltage divider 910, an adaptive minimum off-time controller 920, an adaptive voltage slope detector 930, an adaptive area detector 940, and a logic controller 950. Although the above has been shown using a selected group of components for the turn-on controller 2840, there can be many alternatives, modifications, and variations. For example, some of the components may be expanded and/or combined. Other components may be inserted to those noted above. Depending upon the embodiment, the arrangement of components may be interchanged with others replaced. Further details of these components are found throughout the present specification.

In certain embodiments, the adaptive minimum off-time controller 920 receives the signal 882 (e.g., sr) that is generated by the flip-flop 880 and generates a signal 922 (e.g., ctrl_toff). For example, the signal 922 (e.g., ctrl_toff) represents a minimum off-time duration for the transistor 680 (e.g., a MOSFET MS2) and/or the transistor 780 (e.g., a MOSFET MS2) to remain off after the transistor 680 and/or the transistor 780 becomes turned off respectively. As an example, the signal 922 (e.g., ctrl_toff) represents the minimum off-time duration for the voltage 892 (e.g., a drive voltage) to remain at the logic low level after the voltage 892 (e.g., a drive voltage) changes from the logic high level to the logic low level. As an example, the signal 922 (e.g., ctrl_toff) represents the minimum off-time duration for the signal 882 (e.g., sr) to remain at the logic low level after the signal 882 (e.g., sr) changes from the logic high level to the logic low level. In some examples, the adaptive minimum off-time controller 920 uses the signal 882 (e.g., sr) to determine the minimum off-time duration for a current switching cycle. For example, the signal 882 (e.g., sr) represents an actual off-time duration during the previous switching cycle, immediately preceding the current switching cycle. As an example, the adaptive minimum off-time controller 920 uses the actual off-time duration during the previous switching cycle to determine the minimum off-time duration for the current switching cycle, which immediately follows the previous switching cycle.

As shown in FIG. 9, the voltage divider 910 receives the voltage 832 through the terminal 862 and generates a voltage 912 that is proportional to the voltage 832 according to certain embodiments. For example, the voltage 912 is equal to the voltage 832 multiplied by a predetermined constant, and the predetermined constant is a positive number that is smaller than one. As an example, the voltage 912 is equal to the voltage 832 divided by a predetermined constant, and the predetermined constant is a positive number (e.g., 40) that is larger than one. In some examples, a voltage difference from the voltage 832 to the voltage at the terminal 868 (e.g., GND) is equal to a voltage difference from the drain terminal to the source terminal of the transistor 680 and/or a voltage difference from the drain terminal to the source terminal of the transistor 780. For example, the voltage difference from the voltage 832 to the voltage at the terminal 868 (e.g., GND) is equal to the voltage 832 minus the voltage at the terminal 868 (e.g., GND).

In some embodiments, the adaptive voltage slope detector 930 receives the voltage 912 that is proportional to the voltage 832, receives the signal 853 that is generated by the comparator 852, and generates a signal 932 (e.g., ctrl_slope). For example, when the transistor 830 is turned on, if the voltage 832 changes from being larger than the predetermined threshold voltage (e.g., Vₜ (on)) to being smaller than the predetermined threshold voltage (e.g., Vₜ (on)), the signal 853 (e.g., on det) changes from the logic high level to the logic low level. As an example, the adaptive voltage slope detector 930 uses the voltage 912 and the signal 853 (e.g., on det) to determine a reference voltage for the voltage difference from the voltage 832 to the voltage at the terminal 868 (e.g., GND) and determines the time duration for the voltage difference from the voltage 832 to the voltage at the terminal 868 (e.g., GND) to decrease from the reference voltage to the predetermined threshold voltage (e.g., Vₜ (on)). For example, the signal 932 (e.g., ctrl_slope) indicates whether the time duration is shorter than the predetermined time threshold.

In certain embodiments, the adaptive area detector 940 receives the voltage 912 that is proportional to the voltage 832 and generates a signal 942 (e.g., ctrl_int). For example, the adaptive area detector 940 uses the voltage 912 to determine a reference area for the voltage difference from the voltage 832 to the voltage at the terminal 868 (e.g., GND) and determines an actual area for the voltage difference from the voltage 832 to the voltage at the terminal 868 (e.g., GND). As an example, the signal 942 (e.g., ctrl_int) indicates whether the actual area for the voltage difference from the voltage 832 to the voltage at the terminal 868 (e.g., GND) exceeds the reference area for the voltage difference from the voltage 832 to the voltage at the terminal 868 (e.g., GND). According to some embodiments, the logic controller 950 receives the signal 922 (e.g., ctrl_toff), the signal 932 (e.g., ctrl_slope), and the signal 942 (e.g., ctrl_int), and generates the signal 842 that is received by the NOR gate 844.

According to certain embodiments, the adaptive minimum off-time controller 920 determines, based at least in part on the signal 882 (e.g., sr), an actual off-time duration for the transistor 680 (e.g., a MOSFET MS2) and/or the transistor 780 (e.g., a MOSFET MS2) to remain off in the previous switching cycle, and uses the actual off-time duration in the previous switching cycle to determine a minimum off-time duration for the transistor 680 and/or the transistor 780 to remain off after the transistor 680 and/or the transistor 780 becomes turned off respectively in a current switching cycle. For example, the current switching cycle follows immediately the previous switching cycle. In some examples, the minimum off-time duration in the current switching cycle is equal to the actual off-time duration in the previous switching cycle multiplied by a predetermined constant (e.g., k_{f}). For example, the constant k_{f} is a positive number smaller than one. As an example, the constant k_{f} is equal to 0.75. In certain examples, the adaptive minimum off-time controller 920 generates the signal 922 (e.g., ctrl_toff) to represent the minimum off-time duration in the current switching cycle and sends the signal 922 (e.g., ctrl_toff) to the logic controller 950. For example, after the transistor 680 (e.g., a MOSFET MS2) and/or the transistor 780 (e.g., a MOSFET MS2) becomes turned off, the signal 922 (e.g., ctrl_toff) does not allow the transistor 680 and/or the transistor 780 to become turned on until the transistor 680 and/or the transistor 780 has remained off for the minimum off-time duration. As an example, after the transistor 680 (e.g., a MOSFET MS2) and/or the transistor 780 (e.g., a MOSFET MS2) has remained off for the minimum off-time duration, the signal 922 (e.g., ctrl_toff) allows the transistor 680 and/or the transistor 780 to become turned on.

For example, after the voltage 892 (e.g., a drive voltage) changes from a logic high level to a logic low level, the signal 922 (e.g., ctrl_toff) does not allow the voltage 892 (e.g., a drive voltage) to change from the logic low level to the logic high level until the voltage 892 (e.g., a drive voltage) has remained at the logic low level for the minimum off-time duration. As an example, after the voltage 892 (e.g., a drive voltage) has remained at the logic low level for the minimum off-time duration, the signal 922 (e.g., ctrl_toff) allows the voltage 892 (e.g., a drive voltage) to change from the logic low level to the logic high level. For example, after the signal 882 (e.g., sr) changes from a logic high level to a logic low level, the signal 922 (e.g., ctrl_toff) does not allow the signal 882 (e.g., sr) to change from the logic low level to the logic high level until the signal 882 (e.g., sr) has remained at the logic low level for the minimum off-time duration. As an example, after the signal 882 (e.g., sr) has remained at the logic low level for the minimum off-time duration, the signal 882 (e.g., sr) allows the signal 882 (e.g., sr) to change from the logic low level to the logic high level.

According to some embodiments, a voltage difference from the voltage 832 to the voltage at the terminal 868 (e.g., GND) is equal to a voltage difference from the drain terminal to the source terminal of the transistor 680 and/or a voltage difference from the drain terminal to the source terminal of the transistor 780. For example, the voltage difference from the voltage 832 to the voltage at the terminal 868 (e.g., GND) is equal to the voltage 832 minus the voltage at the terminal 868 (e.g., GND). In certain examples, the adaptive voltage slope detector 930 uses the voltage 912 to determine a reference voltage for the voltage difference from the voltage 832 to the voltage at the terminal 868 and also determines the time duration for the voltage difference from the voltage 832 to the voltage at the terminal 868 to decrease from the reference voltage to the predetermined threshold voltage (e.g., Vₜ (on)). For example, at a falling edge A, the voltage difference from the voltage 832 to the voltage at the terminal 868 falls from a peak magnitude (e.g., V_{dsp}) through a reference voltage to become smaller than a predetermined threshold voltage (e.g., Vₜ (on)). As an example, the reference voltage is equal to the peak magnitude (e.g., V_{dsp}) multiplied by a predetermined constant (e.g., kₛ). For example, the constant kₛ is equal to 0.75. In certain examples, if the falling edge A of the voltage difference from the voltage 832 to the voltage at the terminal 868 causes the transistor 680 (e.g., a MOSFET MS2) and/or the transistor 780 (e.g., a MOSFET MS2) to become turned on, the reference voltage that corresponds to this falling edge A is used for a next falling edge B. In certain examples, at the next falling edge B, the time duration for the voltage difference from the voltage 832 to the voltage at the terminal 868 to decrease from the reference voltage to the predetermined threshold voltage (e.g., Vₜ (on)) is detected, and if the detected time duration is longer than the predetermined time threshold, the signal 932 (e.g., ctrl_slope) does not allow the transistor 680 and/or the transistor 780 to change from being turned off to being turned on. For example, at the next falling edge B, the time duration for the voltage difference from the voltage 832 to the voltage at the terminal 868 to decrease from the reference voltage to the predetermined threshold voltage (e.g., Vₜ (on)) is detected, and if the detected time duration is shorter than the predetermined time threshold, the signal 932 (e.g., ctrl_slope) allows the transistor 680 and/or the transistor 780 to change from being turned off to being turned on. In some examples, at the next falling edge B, if the voltage difference from the voltage 832 to the voltage at the terminal 868 does not even reach the reference voltage before falling to the predetermined threshold voltage (e.g., Vₜ (on)), the signal 932 (e.g., ctrl_slope) does not allow the transistor 680 and/or the transistor 780 to change from being turned off to being turned on.

According to certain embodiments, a voltage difference from the voltage 832 to the voltage at the terminal 868 (e.g., GND) is equal to a voltage difference from the drain terminal to the source terminal of the transistor 680 and/or a voltage difference from the drain terminal to the source terminal of the transistor 780. In certain examples, the adaptive area detector 940 uses the voltage 912 to determine a reference area for the voltage difference from the voltage 832 to the voltage at the terminal 868 (e.g., GND) and also determine an actual area for the voltage difference from the voltage 832 to the voltage at the terminal 868 (e.g., GND). For example, corresponding to a voltage peak of the voltage difference from the voltage 832 to the voltage at the terminal 868, an actual area is determined. As an example, the reference area for the voltage difference from the voltage 832 to the voltage at the terminal 868 (e.g., GND) is equal to the actual area multiplied by a predetermined constant (e.g., kₐ). For example, the predetermined constant kₐ is equal to 0.75.

In certain examples, at a falling edge that corresponds to a voltage peak X of the voltage difference from the voltage 832 to the voltage at the terminal 868, the voltage difference from the voltage 832 to the voltage at the terminal 868 falls from a peak magnitude (e.g., V_{dsp}) through a reference voltage to become smaller than a predetermined threshold voltage (e.g., Vₜ (on)). For example, the reference voltage is equal to the peak magnitude (e.g., V_{dsp}) multiplied by a predetermined constant (e.g., k_{f}). As an example, the predetermined constant kᵣ is equal to 0.5. In some examples, the actual area for the voltage difference from the voltage 832 to the voltage at the terminal 868 (e.g., GND) is an integral area for the voltage difference from the voltage 832 to the voltage at the terminal 868 that is above the reference voltage equal to the peak magnitude (e.g., V_{dsp}) multiplied by the predetermined constant (e.g., kᵣ), and the reference area for the voltage difference from the voltage 832 to the voltage at the terminal 868 (e.g., GND) is equal to the actual area multiplied by a predetermined constant (e.g., kₐ). For example, the predetermined constant kₐ is equal to 0.75. As an example, if the falling edge that corresponds to the voltage peak X of the voltage difference from the voltage 832 to the voltage at the terminal 868 causes the transistor 680 (e.g., a MOSFET MS2) and/or the transistor 780 (e.g., a MOSFET MS2) to become turned on, the reference voltage equal to the peak magnitude (e.g., V_{dsp}) multiplied by the predetermined constant (e.g., kᵣ) and the reference area that corresponds to this voltage peak X are used for a next voltage peak Y. In certain examples, for the next voltage peak Y, an actual area with respect to the reference voltage corresponding to the voltage peak X for the voltage difference from the voltage 832 to the voltage at the terminal 868 (e.g., GND) is determined, and if the determined actual area is smaller than the reference area corresponding to the voltage peak X, the signal 942 (e.g., ctrl_int) does not allow the transistor 680 and/or the transistor 780 to change from being turned off to being turned on. As an example, for the next voltage peak Y, an actual area with respect to the reference voltage corresponding to the voltage peak X for the voltage difference from the voltage 832 to the voltage at the terminal 868 (e.g., GND) is determined, and if the determined actual area is larger than the reference area corresponding to the voltage peak X, the signal 942 (e.g., ctrl_int) allows the transistor 680 and/or the transistor 780 to change from being turned off to being turned on.

As shown in FIG. 9, the logic controller 950 receives the signal 922 (e.g., ctrl_toff), the signal 932 (e.g., ctrl_slope), and the signal 942 (e.g., ctrl_int), and generates the signal 842 that is received by the NOR gate 844 according to some embodiments. In some examples, if all of the signal 922 (e.g., ctrl_toff), the signal 932 (e.g., ctrl_slope), and the signal 942 (e.g., ctrl_int) allow the transistor 680 and/or the transistor 780 to change from being turned off to being turned on, the signal 842 allows the transistor 680 and/or the transistor 780 to change from being turned off to being turned on. For example, if all of the signal 922 (e.g., ctrl_toff), the signal 932 (e.g., ctrl_slope), and the signal 942 (e.g., ctrl_int) allow the voltage 892 (e.g., a drive voltage) to change from a logic low level to a logic high level, the signal 842 allows the voltage 892 (e.g., a drive voltage) to change from the logic low level to the logic high level. As an example, if all of the signal 922 (e.g., ctrl_toff), the signal 932 (e.g., ctrl_slope), and the signal 942 (e.g., ctrl_int) allow the signal 882 (e.g., sr) to change from a logic low level to a logic high level, the signal 842 allows the signal 882 (e.g., sr) to change from the logic low level to the logic high level.

In certain examples, if one or more signals of the signal 922 (e.g., ctrl_toff), the signal 932 (e.g., ctrl_slope), and the signal 942 (e.g., ctrl_int) do not allow the transistor 680 and/or the transistor 780 to change from being turned off to being turned on, the signal 842 does not allow the transistor 680 and/or the transistor 780 to change from being turned off to being turned on. For example, if one or more signals of the signal 922 (e.g., ctrl_toff), the signal 932 (e.g., ctrl_slope), and the signal 942 (e.g., ctrl_int) do not allow the voltage 892 (e.g., a drive voltage) to change from a logic low level to a logic high level, the signal 842 does not allow the voltage 892 (e.g., a drive voltage) to change from the logic low level to the logic high level. As an example, if one or more signals of the signal 922 (e.g., ctrl_toff), the signal 932 (e.g., ctrl_slope), and the signal 942 (e.g., ctrl_int) do not allow the signal 882 (e.g., sr) to change from a logic low level to a logic high level, the signal 842 does not allow the signal 882 (e.g., sr) to change from the logic low level to the logic high level. For example, if the signal 922 (e.g., ctrl_toff), the signal 932 (e.g., ctrl_slope), or the signal 942 (e.g., ctrl_int) does not allow the voltage 892 (e.g., a drive voltage) to change from a logic low level to a logic high level, the signal 842 does not allow the voltage 892 (e.g., a drive voltage) to change from the logic low level to the logic high level. As an example, if the signal 922 (e.g., ctrl_toff), the signal 932 (e.g., ctrl_slope), or the signal 942 (e.g., ctrl_int) does not allow the signal 882 (e.g., sr) to change from a logic low level to a logic high level, the signal 842 does not allow the signal 882 (e.g., sr) to change from the logic low level to the logic high level.

According to certain embodiments, the logic controller 950 includes an OR gate that receives the signal 922 (e.g., ctrl_toff), the signal 932 (e.g., ctrl_slope), and the signal 942 (e.g., ctrl_int), and generates the signal 842. For example, when the signal 922 (e.g., ctrl_toff) is at the logic high level, the signal 922 (e.g., ctrl_toff) does not allow the voltage 892 (e.g., a drive voltage) to change from the logic low level to the logic high level, and when the signal 922 (e.g., ctrl_toff) is at the logic low level, the signal 922 (e.g., ctrl_toff) allows the voltage 892 (e.g., a drive voltage) to change from the logic low level to the logic high level. As an example, when the signal 932 (e.g., ctrl_slope) is at the logic high level, the signal 932 (e.g., ctrl_slope) does not allow the voltage 892 (e.g., a drive voltage) to change from the logic low level to the logic high level, and when the signal 932 (e.g., ctrl_slope) is at the logic low level, the signal 932 (e.g., ctrl_slope) allows the voltage 892 (e.g., a drive voltage) to change from the logic low level to the logic high level. For example, when the signal 942 (e.g., ctrl_int) is at the logic high level, the signal 942 (e.g., ctrl_int) does not allow the voltage 892 (e.g., a drive voltage) to change from the logic low level to the logic high level, and when the signal 942 (e.g., ctrl_int) is at the logic low level, the signal 942 (e.g., ctrl_int) allows the voltage 892 (e.g., a drive voltage) to change from the logic low level to the logic high level.

In some examples, if all of the signal 922 (e.g., ctrl_toff), the signal 932 (e.g., ctrl_slope), and the signal 942 (e.g., ctrl_int) are at the logic low level, the signal 842 is also at the logic low level, allowing the voltage 892 (e.g., a drive voltage) to change from the logic low level to the logic high level. For example, if all of the signal 922 (e.g., ctrl_toff), the signal 932 (e.g., ctrl_slope), and the signal 942 (e.g., ctrl_int) are at the logic low level, the signal 842 is also at the logic low level, allowing the transistor 680 and/or the transistor 780 to change from being turned off to being turned on. In certain examples, if one or more signals of the signal 922 (e.g., ctrl_toff), the signal 932 (e.g., ctrl_slope), and the signal 942 (e.g., ctrl_int) are at the logic high level, the signal 842 is at the logic high level, not allowing the voltage 892 (e.g., a drive voltage) to change from the logic low level to the logic high level. For example, if one or more signals of the signal 922 (e.g., ctrl_toff), the signal 932 (e.g., ctrl_slope), and the signal 942 (e.g., ctrl_int) are at the logic high level, the signal 842 is at the logic high level, not allowing the transistor 680 and/or the transistor 780 to change from being turned off to being turned on. As an example, if the signal 922 (e.g., ctrl_toff), the signal 932 (e.g., ctrl_slope), or the signal 942 (e.g., ctrl_int) is at the logic high level, the signal 842 is at the logic high level, not allowing the transistor 680 and/or the transistor 780 to change from being turned off to being turned on.

As discussed above and further emphasized here, FIG. 9 is merely an example, which should not unduly limit the scope of the claims. One of ordinary skill in the art would recognize many variations, alternatives, and modifications. In some embodiments, one controller of the adaptive minimum off-time controller 920, the adaptive voltage slope detector 930, and the adaptive area detector 940 is removed, so the logic controller 950 receives two signals of the signal 922 (e.g., ctrl_toff), the signal 932 (e.g., ctrl_slope), and the signal 942 (e.g., ctrl_int). For example, if the two received signals both allow the transistor 680 and/or the transistor 780 to change from being turned off to being turned on, the signal 842 allows the transistor 680 and/or the transistor 780 to change from being turned off to being turned on. As an example, if one or two signals of the two received signals do not allow the transistor 680 and/or the transistor 780 to change from being turned off to being turned on, the signal 842 does not allow the transistor 680 and/or the transistor 780 to change from being turned off to being turned on. In some embodiments, two controllers of the adaptive minimum off-time controller 920, the adaptive voltage slope detector 930, and the adaptive area detector 940 are removed, so two signals of the signal 922 (e.g., ctrl_toff), the signal 932 (e.g., ctrl_slope), and the signal 942 (e.g., ctrl_int) are also removed respectively. For example, the logic controller 950 is also removed. As an example, the one remaining signal of the signal 922 (e.g., ctrl_toff), the signal 932 (e.g., ctrl_slope), and the signal 942 (e.g., ctrl_int) is used as the signal 842.

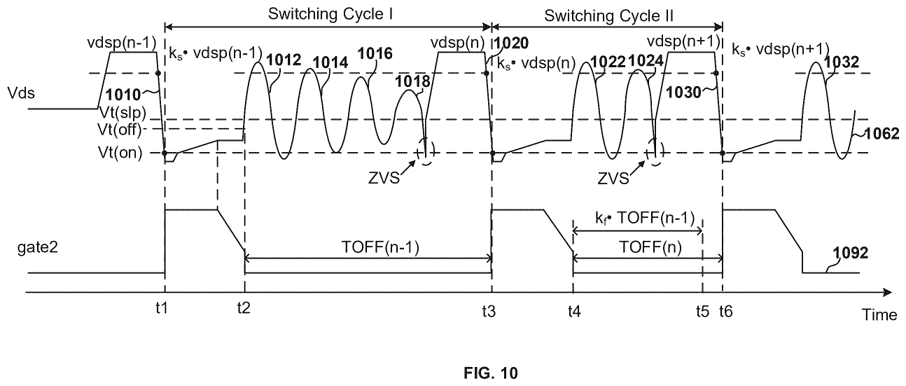

FIG. 10 shows simplified timing diagrams related to the adaptive minimum off-time controller 920 and the adaptive voltage slope detector 930 as shown in FIG. 9 of the controller 860 for synchronous rectification as shown in FIG. 8 as part of the flyback power converter 600 as shown in FIG. 6 and/or as part of the flyback power converter 700 as shown in FIG. 7 according to certain embodiments of the present invention. These diagrams are merely examples, which should not unduly limit the scope of the claims. One of ordinary skill in the art would recognize many variations, alternatives, and modifications. For example, the waveform 1062 represents a voltage difference from the drain terminal to the source terminal of the transistor 680 as a function of time, and the waveform 1092 represents the voltage 696, which is equal to the voltage 892, as a function of time. As an example, the waveform 1062 represents a voltage difference from the drain terminal to the source terminal of the transistor 780 as a function of time, and the waveform 1092 represents the voltage 796, which is equal to the voltage 892, as a function of time.

As shown in FIG. 10, the switching cycle I starts at time t₁ and ends at time t₃, and the switching cycle II starts at time t₃ and ends at time t₆ according to some embodiments. In certain examples, the adaptive minimum off-time controller 920 uses the signal 882 (e.g., sr) to determine an actual off-time duration (e.g., T_{off(n-1)}) from time t₂ to time t₃ in the switching cycle I. For example, during the actual off-time duration (e.g., T_{off(n-1)}) from time t₂ to time t₃, the voltage 892 (e.g., a drive voltage) remains at a logic low level as shown by the waveform 1092. As an example, during the actual off-time duration (e.g., T_{off(n-1)}) from time t₂ to time t₃, the transistor 680 and/or the transistor 780 remains turned off. In some examples, the adaptive minimum off-time controller 920 uses the actual off-time duration (e.g., T_{off(n-1)}) in the switching cycle I to determine the minimum off-time duration in the switching cycle II. As an example, the minimum off-time duration in the switching cycle II is equal to the actual off-time duration (e.g., T_{off(n-1)}) in the switching cycle I multiplied by a predetermined constant (e.g., k_{f}). For example, as shown by the waveform 1092, the voltage 892 (e.g., a drive voltage) changes to the logic low level at time t₄, and the minimum off-time duration starts at time t₄ and ends at time t₅. In certain examples, the signal 922 (e.g., ctrl_toff) generated by the adaptive minimum off-time controller 920 does not allow the voltage 892 (e.g., a drive voltage) to change to the logic high level from time t₄ to time t₅, but the signal 922 (e.g., ctrl_toff) allows the voltage 892 (e.g., a drive voltage) to change to the logic high level after time t₅. For example, as shown by the waveform 1092, at time t₆, the voltage 892 (e.g., a drive voltage) changes to the logic high level.

According to certain embodiments, a voltage difference from the voltage 832 to the voltage at the terminal 868 (e.g., GND) is equal to a voltage difference from the drain terminal to the source terminal of the transistor 680 and/or a voltage difference from the drain terminal to the source terminal of the transistor 780 as shown by the waveform 1062. For example, as shown by the waveform 1062, at a falling edge 1010 (e.g., a falling edge A), the voltage difference from the voltage 832 to the voltage at the terminal 868 falls from a peak magnitude (e.g., V_{dsp(n-1)}) through a reference voltage to become smaller than a predetermined threshold voltage (e.g., Vₜ (on)). As an example, the reference voltage is equal to the peak magnitude (e.g., V_{dsp(n-1)}) multiplied by a predetermined constant (e.g., kₛ). For example, the constant kₛ is equal to 0.75.

In certain examples, as shown by the waveform 1062, the falling edge 1010 (e.g., a falling edge A) of the voltage difference from the voltage 832 to the voltage at the terminal 868 causes the voltage 892 (e.g., a drive voltage) to change from the logic low level to the logic high level, and the reference voltage corresponding to the falling edge 1010 (e.g., a falling edge A) is used for a next falling edge 1012 (e.g., a falling edge B). For example, the reference voltage corresponding to the falling edge 1010 is equal to V_{dsp(n-1)}×kₛ.

In some examples, at the next falling edge 1012 (e.g., a falling edge B), the time duration for the voltage difference from the voltage 832 to the voltage at the terminal 868 to decrease from the reference voltage (e.g., being equal to V_{dsp(n-1)}×kₛ) to the predetermined threshold voltage (e.g., Vₜ (on)) is detected. For example, the detected time duration is longer than the predetermined time threshold (e.g., tₛ), the signal 932 (e.g., ctrl_slope) does not allow the voltage 892 (e.g., a drive voltage) to change from the logic low level to the logic high level, and the reference voltage corresponding to the falling edge 1010 (e.g., a falling edge A) is used for a next falling edge 1014.

In certain examples, at the next falling edge 1016, the voltage difference from the voltage 832 to the voltage at the terminal 868 does not even reach the reference voltage (e.g., being equal to V_{dsp(n-1)}×kₛ), the signal 932 (e.g., ctrl_slope) does not allow the voltage 892 (e.g., a drive voltage) to change from the logic low level to the logic high level, and the reference voltage corresponding to the falling edge 1010 (e.g., a falling edge A) is used for a next falling edge 1018. In some examples, at the next falling edge 1018, the voltage difference from the voltage 832 to the voltage at the terminal 868 does not even reach the reference voltage (e.g., being equal to V_{dsp(n-1)}×kₛ), the signal 932 (e.g., ctrl_slope) does not allow the voltage 892 (e.g., a drive voltage) to change from the logic low level to the logic high level, and the reference voltage corresponding to the falling edge 1010 (e.g., a falling edge A) is used for a next falling edge 1020.

According to some embodiments, at the next falling edge 1020, the time duration for the voltage difference from the voltage 832 to the voltage at the terminal 868 to decrease from the reference voltage (e.g., being equal to V_{dsp(n-1)}×kₛ) to the predetermined threshold voltage (e.g., Vₜ (on)) is detected. In certain examples, at the next falling edge 1020, the voltage difference from the voltage 832 to the voltage at the terminal 868 falls from another peak magnitude (e.g., V_{dsp(n)}) through the reference voltage equal to V_{dsp(n-1)}×kₛ and also through another reference voltage equal to V_{dsp(n)}×kₛ to become smaller than the predetermined threshold voltage (e.g., Vₜ (on)). For example, the detected time duration for the voltage difference from the voltage 832 to the voltage at the terminal 868 to decrease from the reference voltage (e.g., being equal to V_{dsp(n-1)}×kₛ) to the predetermined threshold voltage (e.g., Vₜ (on)) is shorter than the predetermined time threshold (e.g., tₛ), and the signal 932 (e.g., ctrl_slope) allows the voltage 892 (e.g., a drive voltage) to change from the logic low level to the logic high level. In some examples, as shown by the waveform 1092, in response to the falling edge 1020, the voltage 892 (e.g., a drive voltage) changes from the logic low level to the logic high level. As an example, this another reference voltage that corresponds to the falling edge 1020 (e.g., being equal to V_{dsp(n)}×kₛ) is used for a next falling edge 1022.

In some examples, at the next falling edge 1022, the time duration for the voltage difference from the voltage 832 to the voltage at the terminal 868 to decrease from the reference voltage (e.g., being equal to V_{dsp(n)}×kₛ) to the predetermined threshold voltage (e.g., Vₜ (on)) is detected. For example, the detected time duration is longer than the predetermined time threshold (e.g., tₛ), the signal 932 (e.g., ctrl_slope) does not allow the voltage 892 (e.g., a drive voltage) to change from the logic low level to the logic high level, and the reference voltage corresponding to the falling edge 1020 (e.g., being equal to V_{dsp(n)}×kₛ) is used for a next falling edge 1024.

In certain examples, at the next falling edge 1024, the time duration for the voltage difference from the voltage 832 to the voltage at the terminal 868 to decrease from the reference voltage (e.g., being equal to V_{dsp(n)}×kₛ) to the predetermined threshold voltage (e.g., Vₜ (on)) is detected. For example, the detected time duration is shorter than the predetermined time threshold (e.g., tₛ), the signal 932 (e.g., ctrl_slope) allows the voltage 892 (e.g., a drive voltage) to change from the logic low level to the logic high level, but the signal 922 (e.g., ctrl_toff) generated by the adaptive minimum off-time controller 920 does not allow the voltage 892 (e.g., a drive voltage) to change to the logic high level from time t₄ to time t₅. As an example, the next falling edge 1024 does not cause the voltage 892 (e.g., a drive voltage) to change to the logic high level, and the reference voltage corresponding to the falling edge 1020 (e.g., being equal to V_{dsp(n)}×kₛ) is used for a next falling edge 1030.

According to certain embodiments, at the next falling edge 1030, the time duration for the voltage difference from the voltage 832 to the voltage at the terminal 868 to decrease from the reference voltage (e.g., being equal to V_{dsp(n)}×kₛ) to the predetermined threshold voltage (e.g., Vₜ (on)) is detected. In certain examples, at the next falling edge 1030, the voltage difference from the voltage 832 to the voltage at the terminal 868 falls from another peak magnitude (e.g., V_{dsp(n+1)}) through the reference voltage equal to V_{dsp(n)}×kₛ and also through another reference voltage equal to V_{dsp(n+1)}×kₛ to become smaller than the predetermined threshold voltage (e.g., Vₜ (on)). For example, the detected time duration for the voltage difference from the voltage 832 to the voltage at the terminal 868 to decrease from the reference voltage (e.g., being equal to V_{dsp(n)}×kₛ) to the predetermined threshold voltage (e.g., Vₜ (on)) is shorter than the predetermined time threshold (e.g., tₛ), and the signal 932 (e.g., ctrl_slope) allows the voltage 892 (e.g., a drive voltage) to change from the logic low level to the logic high level. In some examples, as shown by the waveform 1092, in response to the falling edge 1030, the voltage 892 (e.g., a drive voltage) changes from the logic low level to the logic high level. As an example, this another reference voltage that corresponds to the falling edge 1030 (e.g., being equal to V_{dsp(n+1)}×kₛ) is used for a next falling edge 1032.

As discussed above and further emphasized here, FIG. 10 is merely an example, which should not unduly limit the scope of the claims. One of ordinary skill in the art would recognize many variations, alternatives, and modifications. For example, the minimum off-time duration in the switching cycle II is equal to the actual off-time duration (e.g., T_{off(n-1)}) in the switching cycle I multiplied by the predetermined constant k_{f} (e.g., 0.75) if the actual off-time duration (e.g., T_{off(n-1)} in the switching cycle I multiplied by the predetermined constant k_{f} (e.g., 0.75) is larger than or equal to a predetermined minimum value (e.g., 2 μs) of the minimum off-time duration. As an example, if the actual off-time duration (e.g., T_{off(n-1)}) in the switching cycle I multiplied by the predetermined constant k_{f} (e.g., 0.75) is smaller than the predetermined minimum value (e.g., 2 μs) of the minimum off-time duration, the minimum off-time duration in the switching cycle II is equal to the predetermined minimum value (e.g., 2 μs).

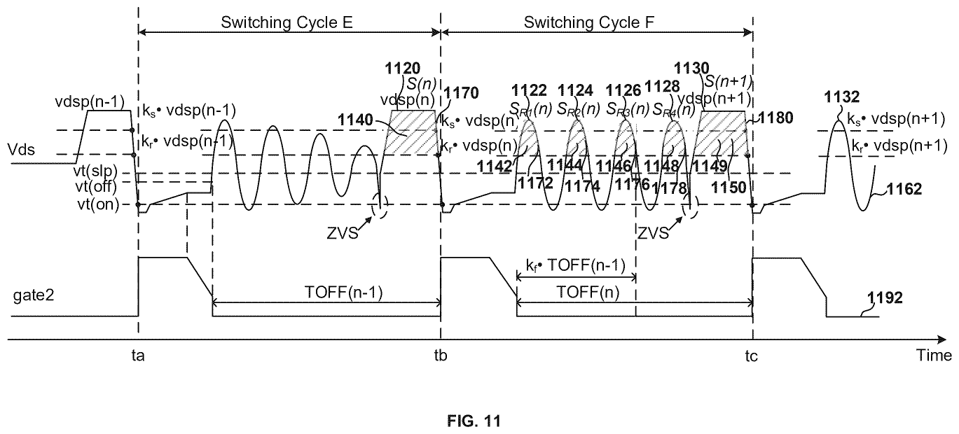

FIG. 11 shows simplified timing diagrams related to the adaptive area detector 940 as shown in FIG. 9 of the controller 860 for synchronous rectification as shown in FIG. 8 as part of the flyback power converter 600 as shown in FIG. 6 and/or as part of the flyback power converter 700 as shown in FIG. 7 according to some embodiments of the present invention. These diagrams are merely examples, which should not unduly limit the scope of the claims. One of ordinary skill in the art would recognize many variations, alternatives, and modifications. For example, the waveform 1162 represents a voltage difference from the drain terminal to the source terminal of the transistor 680 as a function of time, and the waveform 1192 represents the voltage 696, which is equal to the voltage 892, as a function of time. As an example, the waveform 1162 represents a voltage difference from the drain terminal to the source terminal of the transistor 780 as a function of time, and the waveform 1192 represents the voltage 796, which is equal to the voltage 892, as a function of time.

As shown in FIG. 11, the switching cycle E starts at time tₐ and ends at time t_{b}, and the switching cycle F starts at time t_{b} and ends at time t_{c} according to certain embodiments. According to some embodiments, a voltage difference from the voltage 832 to the voltage at the terminal 868 (e.g., GND) is equal to a voltage difference from the drain terminal to the source terminal of the transistor 680 and/or a voltage difference from the drain terminal to the source terminal of the transistor 780 as shown by the waveform 1162. For example, as shown by the waveform 1162, at a falling edge 1170 that corresponds to a voltage peak 1120 (e.g., a voltage peak X) of the voltage difference from the voltage 832 to the voltage at the terminal 868, the voltage difference from the voltage 832 to the voltage at the terminal 868 falls from a peak magnitude (e.g., V_{dsp(n)}) through a reference voltage to become smaller than a predetermined threshold voltage (e.g., Vₜ (on)). As an example, the reference voltage is equal to the peak magnitude (e.g., V_{dsp(n)}) multiplied by a predetermined constant (e.g., kᵣ). For example, the constant kᵣ is equal to 0.5. In some examples, an actual area 1140 (e.g., Sₙ) for the voltage difference from the voltage 832 to the voltage at the terminal 868 (e.g., GND) is an integral area for the voltage difference from the voltage 832 to the voltage at the terminal 868 that is above the reference voltage equal to the peak magnitude (e.g., V_{dsp(n)}) multiplied by a predetermined constant (e.g., kᵣ), and corresponding to the voltage peak 1120 (e.g., a voltage peak X), the reference area for the voltage difference from the voltage 832 to the voltage at the terminal 868 (e.g., GND) is equal to the actual area (e.g., Sₙ) multiplied by a predetermined constant (e.g., kₐ).

In certain examples, as shown by the waveform 1162, the falling edge 1170 that corresponds to the voltage peak 1120 (e.g., a voltage peak X) of the voltage difference from the voltage 832 to the voltage at the terminal 868 causes the voltage 892 (e.g., a drive voltage) to change from the logic low level to the logic high level, and the reference voltage equal to the peak magnitude (e.g., V_{dsp(n)}) multiplied by the predetermined constant (e.g., kᵣ) and the reference area that corresponds to the voltage peak 1120 are used for a next voltage peak 1122 (e.g., a voltage peak Y). For example, the reference voltage corresponding to the voltage peak 1120 is equal to V_{dsp(n)}×kᵣ. As an example, the reference area corresponding to the voltage peak 1120 is equal to Sₙ×kₐ.

In some examples, for the voltage peak 1122 (e.g., a voltage peak Y), an actual area 1142 (e.g., Sᵣₙₐ) for the voltage difference from the voltage 832 to the voltage at the terminal 868 (e.g., GND) is an integral area for the voltage difference from the voltage 832 to the voltage at the terminal 868 that is above the reference voltage equal to the peak magnitude (e.g., V_{dsp(n)}) multiplied by a predetermined constant (e.g., kᵣ). For example, the actual area 1142 (e.g., Sᵣₙₐ) for the voltage peak 1122 (e.g., a voltage peak Y) is smaller than the reference area corresponding to the voltage peak 1120 and equal to Sₙ×kₐ, and the signal 942 (e.g., ctrl_int) does not allow the voltage 892 (e.g., a drive voltage) to change from the logic low level to the logic high level. As an example, a falling edge 1172 that corresponds to the voltage peak 1122 of the voltage difference from the voltage 832 to the voltage at the terminal 868 does not cause the voltage 892 (e.g., a drive voltage) to change from the logic low level to the logic high level, and the reference voltage equal to the peak magnitude (e.g., V_{dsp(n)}) multiplied by the predetermined constant (e.g., kᵣ) and the reference area that corresponds to the voltage peak 1120 are used for a next voltage peak 1124.

In certain examples, for the voltage peak 1124, an actual area 1144 (e.g., S_{rnb}) for the voltage difference from the voltage 832 to the voltage at the terminal 868 (e.g., GND) is an integral area for the voltage difference from the voltage 832 to the voltage at the terminal 868 that is above the reference voltage equal to the peak magnitude (e.g., V_{dsp(n)}) multiplied by a predetermined constant (e.g., kᵣ). For example, the actual area 1144 (e.g., S_{rnb}) for the voltage peak 1124 is smaller than the reference area corresponding to the voltage peak 1120 and equal to Sₙ×kₐ, and the signal 942 (e.g., ctrl_int) does not allow the voltage 892 (e.g., a drive voltage) to change from the logic low level to the logic high level. As an example, a falling edge 1174 that corresponds to the voltage peak 1124 of the voltage difference from the voltage 832 to the voltage at the terminal 868 does not cause the voltage 892 (e.g., a drive voltage) to change from the logic low level to the logic high level, and the reference voltage equal to the peak magnitude (e.g., V_{dsp(n)}) multiplied by the predetermined constant (e.g., kᵣ) and the reference area that corresponds to the voltage peak 1120 are used for a next voltage peak 1126.

In some examples, for the voltage peak 1126, an actual area 1146 (e.g., S_{rnc}) for the voltage difference from the voltage 832 to the voltage at the terminal 868 (e.g., GND) is an integral area for the voltage difference from the voltage 832 to the voltage at the terminal 868 that is above the reference voltage equal to the peak magnitude (e.g., V_{dsp(n)}) multiplied by a predetermined constant (e.g., kᵣ). For example, the actual area 1146 (e.g., S_{rnc}) for the voltage peak 1126 is smaller than the reference area corresponding to the voltage peak 1120 and equal to Sₙ×kₐ, and the signal 942 (e.g., ctrl_int) does not allow the voltage 892 (e.g., a drive voltage) to change from the logic low level to the logic high level. As an example, a falling edge 1176 that corresponds to the voltage peak 1126 of the voltage difference from the voltage 832 to the voltage at the terminal 868 does not cause the voltage 892 (e.g., a drive voltage) to change from the logic low level to the logic high level, and the reference voltage equal to the peak magnitude (e.g., V_{dsp(n)}) multiplied by the predetermined constant (e.g., kᵣ) and the reference area that corresponds to the voltage peak 1120 are used for a next voltage peak 1128.

In certain examples, for the voltage peak 1128, an actual area 1148 (e.g., S_{rnd}) for the voltage difference from the voltage 832 to the voltage at the terminal 868 (e.g., GND) is an integral area for the voltage difference from the voltage 832 to the voltage at the terminal 868 that is above the reference voltage equal to the peak magnitude (e.g., V_{dsp(n)}) multiplied by a predetermined constant (e.g., kᵣ). For example, the actual area 1148 (e.g., S_{rnd}) for the voltage peak 1128 is smaller than the reference area corresponding to the voltage peak 1120 and equal to Sₙ×kₐ, and the signal 942 (e.g., ctrl_int) does not allow the voltage 892 (e.g., a drive voltage) to change from the logic low level to the logic high level. As an example, a falling edge 1178 that corresponds to the voltage peak 1128 of the voltage difference from the voltage 832 to the voltage at the terminal 868 does not cause the voltage 892 (e.g., a drive voltage) to change from the logic low level to the logic high level, and the reference voltage equal to the peak magnitude (e.g., V_{dsp(n)}) multiplied by the predetermined constant (e.g., kᵣ) and the reference area that corresponds to the voltage peak 1120 are used for a next voltage peak 1130.

According to some embodiments, for the voltage peak 1130, an actual area 1149 (e.g., S_{rnc}) for the voltage difference from the voltage 832 to the voltage at the terminal 868 (e.g., GND) is an integral area for the voltage difference from the voltage 832 to the voltage at the terminal 868 that is above the reference voltage equal to the peak magnitude (e.g., V_{dsp(n)}) multiplied by a predetermined constant (e.g., kᵣ). For example, the actual area 1149 (e.g., Sᵣₙₑ) for the voltage peak 1130 is larger than the reference area corresponding to the voltage peak 1120 and equal to Sₙ×kₐ, and the signal 942 (e.g., ctrl_int) allows the voltage 892 (e.g., a drive voltage) to change from the logic low level to the logic high level. As an example, a falling edge 1180 that corresponds to the voltage peak 1130 of the voltage difference from the voltage 832 to the voltage at the terminal 868 causes the voltage 892 (e.g., a drive voltage) to change from the logic low level to the logic high level.

According to certain embodiments, as shown by the waveform 1162, at the falling edge 1180 that corresponds to the voltage peak 1130 of the voltage difference from the voltage 832 to the voltage at the terminal 868, the voltage difference from the voltage 832 to the voltage at the terminal 868 falls from a peak magnitude (e.g., V_{dsp(n+1)}) through the reference voltage equal to the peak magnitude (e.g., V_{dsp(n)}) multiplied by a predetermined constant (e.g., kᵣ) and also through another reference voltage to become smaller than the predetermined threshold voltage (e.g., Vₜ (on)). For example, this another reference voltage is equal to the peak magnitude (e.g., V_{dsp(n+1)}) multiplied by a predetermined constant (e.g., kᵣ). For example, the constant kᵣ is equal to 0.5. As an example, an actual area 1150 (e.g., S₍ₙ₊₁₎) for the voltage difference from the voltage 832 to the voltage at the terminal 868 (e.g., GND) is an integral area for the voltage difference from the voltage 832 to the voltage at the terminal 868 that is above the reference voltage equal to the peak magnitude (e.g., V_{dsp(n+1)}) multiplied by a predetermined constant (e.g., kᵣ), and corresponding to the voltage peak 1130, the reference area for the voltage difference from the voltage 832 to the voltage at the terminal 868 (e.g., GND) is equal to the actual area (e.g., S₍ₙ₊₁₎) multiplied by a predetermined constant (e.g., kₐ).

In some examples, the falling edge 1180 that corresponds to the voltage peak 1130 of the voltage difference from the voltage 832 to the voltage at the terminal 868 causes the voltage 892 (e.g., a drive voltage) to change from the logic low level to the logic high level, and the reference voltage equal to the peak magnitude (e.g., V_{dsp(n+1)}) multiplied by the predetermined constant (e.g., kᵣ) and the reference area that corresponds to the voltage peak 1130 are used for a next voltage peak 1132. In certain examples, the peak magnitude V_{dsp(n)} is equal to the peak magnitude V_{dsp(n+1)}. For example, the reference voltage equal to the peak magnitude V_{dsp(n)} multiplied by the predetermined constant kᵣ is equal to this another reference voltage equal to the peak magnitude V_{dsp(n+1)} multiplied by the predetermined constant kᵣ. As an example, for the voltage peak 1130, the actual area 1149 (e.g., S_{rnc}) is equal to an actual area 1150 (e.g., S₍ₙ₊₁₎).

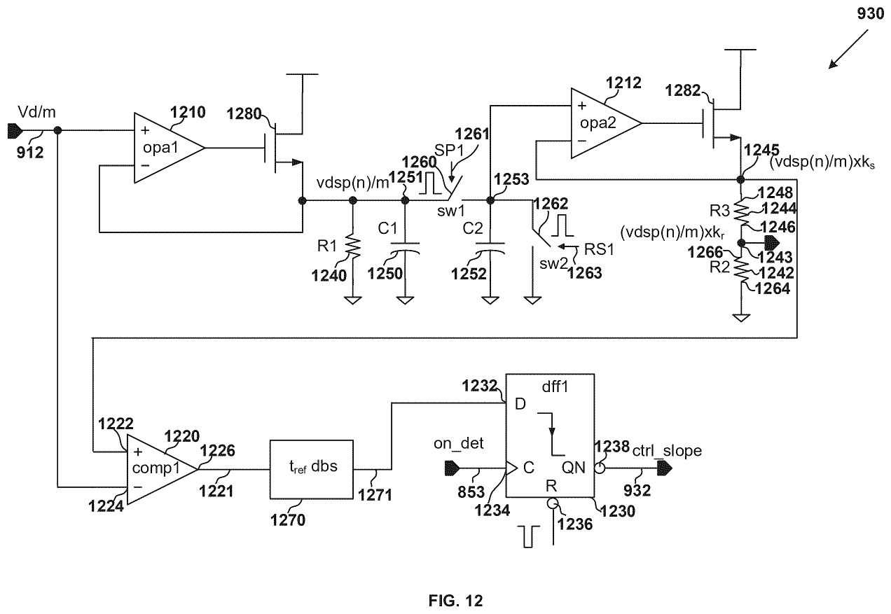

FIG. 12 is a simplified diagram showing the adaptive voltage slope detector 930 as shown in FIG. 9 of the controller 860 for synchronous rectification as shown in FIG. 8 as part of the flyback power converter 600 as shown in FIG. 6 and/or as part of the flyback power converter 700 as shown in FIG. 7 according to certain embodiments of the present invention. This diagram is merely an example, which should not unduly limit the scope of the claims. One of ordinary skill in the art would recognize many variations, alternatives, and modifications. The adaptive voltage slope detector 930 includes an operational amplifier 1210 (e.g., opa1), an operational amplifier 1212 (e.g., opa2), a comparator 1220 (e.g., comp1), a flip-flop 1230 (e.g., dff1), a resistor 1240 (e.g., R1), a resistor 1242 (e.g., R2), a resistor 1244 (e.g., R3), a capacitor 1250 (e.g., C1), a capacitor 1252 (e.g., C2), a switch 1260 (e.g., sw1), a switch 1262 (e.g., sw2), a timer 1270 (e.g., t_{ref} dbs), and transistors 1280 and 1282. For example, the flip-flop 1230 (e.g., dff1) is a D flip-flop (e.g., a falling-edge-triggered D flip-flop). As an example, the resistor 1240 (e.g., R1) has large resistance.

As shown in FIG. 12, the peak magnitude of the voltage 912 is stored on the capacitor 1250 (e.g., C1) according to some embodiments. For example, the voltage 912 is equal to the voltage 832 divided by a predetermined divider constant (e.g., m) of the voltage divider 910. As an example, the predetermined divider constant m is equal to 40. In certain examples, the peak magnitude of the voltage 912 is equal to the peak magnitude of the voltage 832 (e.g., V_{dsp(n)}) divided by the predetermined divider constant m. As an example, a voltage 1251 (e.g., VC1) of the capacitor 1250 (e.g., C1) is equal to

$$\frac{{V}_{dsp ( n )}}{m} .$$

According to certain embodiments, at a rising edge of the voltage 892 (e.g., a drive voltage) when the voltage 892 changes from a logic low level to a logic high level, a signal 1263 (e.g., RS1) provides a narrow pulse to briefly close the switch 1262 (e.g., sw2) in order to 8 the capacitor 1252 (e.g., C2), and then a signal 1261 (e.g., SP1) provides a pulse with a predetermined width to connect the capacitors 1250 (e.g., C1) and 1252 (e.g., C2). For example, a voltage 1253 (e.g., VC2) of the capacitor 1252 (e.g., C2) is determined as follows:

$${V}_{C 2} = \frac{{C}_{1}}{( {C}_{1} + {C}_{2} )} \times \frac{{V}_{dsp ( n )}}{m} \qquad ( Equation 5 )$$

where V_{C2} represents the voltage 1253 of the capacitor 1252. Additionally, C₁ represents the capacitance of the capacitor 1250, and C₂ represents the capacitance of the capacitor 1252. Moreover, V_{dsp(n)} represents the peak magnitude of the voltage 832, and m represents the predetermined divider constant of the voltage divider 910.

In some embodiments, the voltage 1253 (e.g., V_{C2}) of the capacitor 1252 (e.g., C₂) is received by a buffer stage that includes the operational amplifier 1212 (e.g., opa2), the resistor 1242 (e.g., R2), the resistor 1244 (e.g., R3), and the transistor 1282. In certain examples, the resistor 1242 (e.g., R2) includes terminals 1264 and 1266, and the resistor 1244 (e.g., R3) includes terminals 1246 and 1248. For example, the terminal 1264 is biased to the ground voltage on the secondary side of the flyback power converter 600 and/or the flyback power converter 700. As an example, the terminals 1266 and 1246 are connected to generate a voltage 1243. For example, the terminal 1248 is connected to the operational amplifier 1212 (e.g., opa2) and the transistor 1282 and is biased to a voltage 1245. In some examples, the voltage 1245 is equal to

$$\frac{{V}_{dsp ( n )}}{m} \times {k}_{s} ,$$

where V_{dsp(n)} represents the peak magnitude of the voltage 832, m represents the predetermined divider constant of the voltage divider 910, and kₛ represents a predetermined constant (e.g., 0.75). In certain examples, the voltage 1243 is equal to

$$\frac{{V}_{dsp ( n )}}{m} \times {k}_{r} ,$$

where V_{dsp(n)} represents the peak magnitude of the voltage 832, m represents the predetermined divider constant (e.g., 40) of the voltage divider 910, and kᵣ represents a predetermined constant (e.g., 0.5).

In certain embodiments, the comparator 1220 (e.g., comp1) includes a non-inverting input terminal 1222 (e.g., the “+” terminal), an inverting input terminal 1224 (e.g., the “−” terminal), and an output terminal 1226. For example, the non-inverting input terminal 1222 (e.g., the “+” terminal) receives the voltage 1245. As an example, the inverting input terminal 1224 (e.g., the “−” terminal) of the comparator 1220 (e.g., comp1) receives the voltage 912, which is equal to the voltage 832 divided by the predetermined divider constant m (e.g., 40). For example, the output terminal 1226 of the comparator 1220 (e.g., comp1) outputs an output signal 1221.

According to certain embodiments, if the voltage 912 becomes smaller than the voltage 1253 (e.g., V_{C2}), the comparator changes the output signal 1221 from a logic low level to a logic high level. For example, the output signal 1221 is received by the timer 1270 (e.g., t_{ref} dbs), which in response generates a signal 1271. As an example, in response to the output signal 1221 changing from the logic low level to the logic high level, the timer 1270 (e.g., t_{ref} dbs) changes the signal 1271 from the logic low level to the logic high level, keeps the signal 1271 at the logic high level for a predetermined reference time duration (e.g., T_{ref}), and then changes the signal 1271 from the logic high level back to the logic low level.

As shown in FIG. 12, the flip-flop 1230 (e.g., dff1) includes a terminal 1232 (e.g., D), a terminal 1234 (e.g., C), a terminal 1236 (e.g., R), and a terminal 1238 (e.g., QN) according to some embodiments. For example, the terminal 1232 (e.g., D) receives the signal 1271, and the terminal 1234 (e.g., C) receives the signal 853 (e.g., on det). As an example, when the transistor 830 is turned on, if the voltage 832 changes from being larger than the predetermined threshold voltage (e.g., Vₜ (on)) to being smaller than the predetermined threshold voltage (e.g., Vₜ (on)), the signal 853 (e.g., on det) changes from the logic high level to the logic low level. In certain examples, when the signal 853 (e.g., on det) changes from the logic high level to the logic low level, the flip-flop 1230 (e.g., dff1) samples the signal 1271, generates the signal 932 based at least in part on the sampled signal 1271, and outputs the signal 932 at the terminal 1238 (e.g., QN). For example, if the sampled signal 1271 is at the logic high level, the flip-flop 1230 (e.g., dff1) generates the signal 932 at the logic low level. As an example, if the sampled signal 1271 is at the logic low level, the flip-flop 1230 (e.g., dff1) generates the signal 932 at the logic high level.

In certain embodiments, if the signal 853 (e.g., on det) changes from the logic high level to the logic low level during the predetermined reference time duration (e.g., T_{ref}) in response to the output signal 1221 changing from the logic low level to the logic high level, the signal 932 is at the logic low level, allowing the transistor 680 and/or the transistor 780 to change from being turned off to being turned on. In some embodiments, if the signal 853 (e.g., on det) changes from the logic high level to the logic low level after the predetermined reference time duration (e.g., T_{ref}) in response to the output signal 1221 changing from the logic low level to the logic high level, the signal 932 is at the logic high level, not allowing the transistor 680 and/or the transistor 780 to change from being turned off to being turned on.

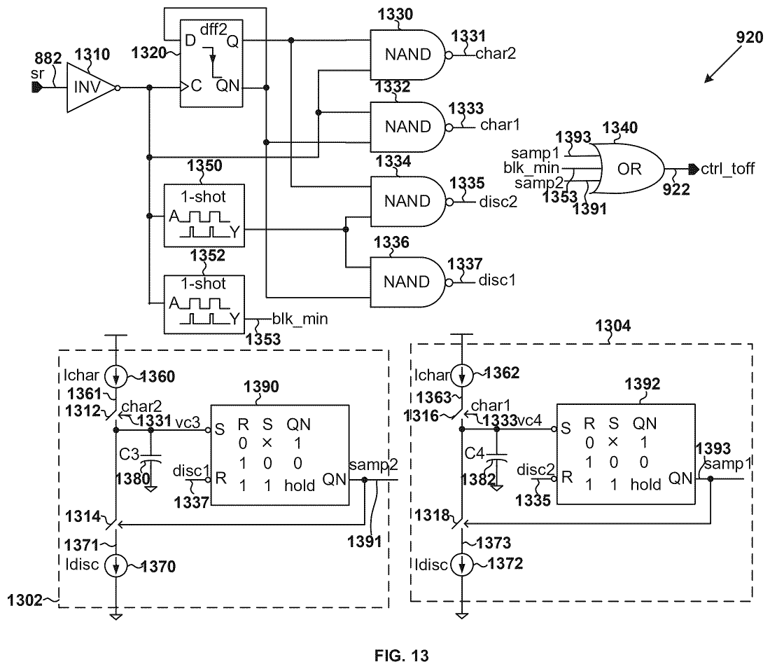

FIG. 13 is a simplified diagram showing the adaptive minimum off-time controller 920 as shown in FIG. 9 of the controller 860 for synchronous rectification as shown in FIG. 8 as part of the flyback power converter 600 as shown in FIG. 6 and/or as part of the flyback power converter 700 as shown in FIG. 7 according to certain embodiments of the present invention. This diagram is merely an example, which should not unduly limit the scope of the claims. One of ordinary skill in the art would recognize many variations, alternatives, and modifications. The adaptive minimum off-time controller 920 includes a NOT gate 1310 (e.g., INV), switches 1312, 1314, 1316 and 1318, a flip-flop 1320 (e.g., dff2), NAND gates 1330, 1332, 1334 and 1336, an OR gate 1340, one-shot pulse generators 1350 and 1352, current sources 1360 and 1362, current sinks 1370 and 1372, capacitors 1380 and 1382, and flip-flops 1390 and 1392. For example, the flip-flop 1320 (e.g., dff2) is a D flip-flop. As an example, the one-shot pulse generator 1350 generates one or more pulses that are at a high voltage level (e.g., at a high-voltage level that corresponds to a logic high level), and the one-shot pulse generator 1352 generates one or more pulses that are at a high voltage level (e.g., at a high-voltage level that corresponds to a logic high level).

As shown in FIG. 13, a charging and discharging circuit 1302 includes the switches 1312 and 1314, the current source 1360, the current sink 1370, the capacitor 1380 (e.g., C3) and the flip-flop 1390, and a charging and discharging circuit 1304 includes the switches 1316 and 1318, the current source 1362, the current sink 1372, the capacitor 1382 (e.g., C3) and the flip-flop 1392, according to some embodiments. In certain examples, the current source 1360 generates a charging current 1361, and the current sink 1370 generates a discharging current 1371. For example, a ratio of the charging current 1361 to the discharging current 1371 in magnitude is determined as follows:

$${k}_{f} = \frac{{I}_{1361}}{{I}_{1371}} \qquad ( Equation 6 )$$

where k_{f} represents the ratio of the charging current 1361 to the discharging current 1371 in magnitude. I₁₃₆₁ represents the magnitude of the charging current 1361, and I₁₃₇₁ represents the magnitude of the discharging current 1371. As an example, the ratio k_{f} is equal to 0.75. In some examples, the current source 1362 generates a charging current 1363, and the current sink 1372 generates a discharging current 1373. For example, a ratio of the charging current 1363 to the discharging current 1373 in magnitude is determined as follows:

$${k}_{f} = \frac{{I}_{1363}}{{I}_{1373}} \qquad ( Equation 7 )$$

where k_{f} represents the ratio of the charging current 1363 to the discharging current 1373 in magnitude. I₁₃₆₃ represents the magnitude of the charging current 1363, and I₁₃₇₃ represents the magnitude of the discharging current 1373. As an example, the ratio k_{f} is equal to 0.75.

In certain embodiments, the NAND gate 1330 generates a logic signal 1331 (e.g., char2), the NAND gate 1332 generates a logic signal 1333 (e.g., char1), the NAND gate 1334 generates a logic signal 1335 (e.g., disc2), and the NAND gate 1336 generates a logic signal 1337 (e.g., disc1). In some examples, the logic signal 1331 (e.g., char2) is received by the switch 1312 to open and/or close the switch 1312, and the logic signal 1333 (e.g., char1) is received by the switch 1316 to open and/or close the switch 1316. As an example, the logic signal 1337 (e.g., disc1) is received by the flip-flop 1390, and in response, the flip-flop 1390 generates a signal 1391 (e.g., samp2). For example, the logic signal 1335 (e.g., disc2) is received by the flip-flop 1392, and in response, the flip-flop 1392 generates a signal 1393 (e.g., samp1). In certain examples, the signal 1391 (e.g., samp2) is received by the switch 1314 to open and/or close the switch 1314, and the signal 1393 (e.g., samp1) is received by the switch 1318 to open and/or close the switch 1318. For example, if the logic signal 1331 (e.g., char2) is at a logic high level, the switch 1312 is closed to charge the capacitor 1380 (e.g., C3) with the charging current 1361 generated by the current source 1360 (e.g., Ichar), and if the signal 1391 (e.g., samp2) is at a logic high level, the switch 1314 is closed to discharge the capacitor 1380 (e.g., C3) with the discharging current 1371 generated by the current sink 1370 (e.g., Idisc). As an example, if the logic signal 1333 (e.g., char1) is at a logic high level, the switch 1316 is closed to charge the capacitor 1382 (e.g., C4) with the charging current 1363 generated by the current source 1362 (e.g., Ichar), and if the signal 1393 (e.g., samp1) is at a logic high level, the switch 1316 is closed to discharge the capacitor 1382 (e.g., C4) with the discharging current 1373 generated by the current sink 1372 (e.g., Idisc).

In some embodiments, the charging and discharging circuit 1302 and the charging and discharging circuit 1304 operate alternately. For example, the current source 1360 and the current source 1362 alternately charge the capacitor 1380 (e.g., C3) and the capacitor 1382 (e.g., C4) respectively, and the amount of charge stored on the capacitor 1380 (e.g., C3) or the capacitor 1382 (e.g., C4) indicates an actual off-time duration during a previous switching cycle alternately. As an example, the current sink 1370 and the current sink 1372 alternately discharge the capacitor 1380 (e.g., C3) and the capacitor 1382 (e.g., C4) respectively, and the time needed for discharging the capacitor 1380 (e.g., C3) or the capacitor 1382 (e.g., C4) indicates the minimum off-time duration for a current switching cycle alternately.

According to certain embodiments, the one-shot pulse generator 1352 generates a pulse signal 1353 (e.g., blk_min), which indicates a predetermined minimum value (e.g., 2 μs) of the minimum off-time duration. In some examples, the pulse signal 1353 (e.g., blk_min) is received by the OR gate 1340, which also receives the signal 1391 (e.g., samp2) and the signal 1393 (e.g., samp1) and generates the signal 922 (e.g., ctrl_toff). For example, if all of the signal 1391 (e.g., samp2), the signal 1393 (e.g., samp1), and the pulse signal 1353 (e.g., blk_min) are at a logic low level, the signal 922 (e.g., ctrl_toff) is also at the logic low level, allowing the voltage 892 (e.g., a drive voltage) to change from the logic low level to the logic high level. As an example, if one or more signals of the signal 1391 (e.g., samp2), the signal 1393 (e.g., samp1), and the pulse signal 1353 (e.g., blk_min) are at a logic high level, the signal 922 (e.g., ctrl_toff) is also at the logic high level, not allowing the voltage 892 (e.g., a drive voltage) to change from the logic low level to the logic high level. For example, if the signal 1391 (e.g., samp2), the signal 1393 (e.g., samp1), or the pulse signal 1353 (e.g., blk_min) is at a logic high level, the signal 922 (e.g., ctrl_toff) is also at the logic high level, not allowing the voltage 892 (e.g., a drive voltage) to change from the logic low level to the logic high level.

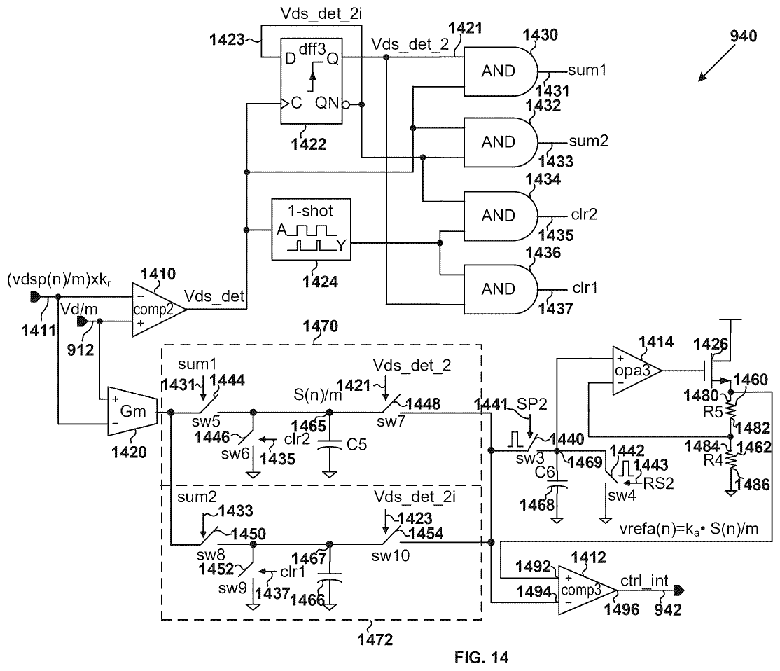

FIG. 14 is a simplified diagram showing the adaptive area detector 940 as shown in FIG. 9 of the controller 860 for synchronous rectification as shown in FIG. 8 as part of the flyback power converter 600 as shown in FIG. 6 and/or as part of the flyback power converter 700 as shown in FIG. 7 according to certain embodiments of the present invention. This diagram is merely an example, which should not unduly limit the scope of the claims. One of ordinary skill in the art would recognize many variations, alternatives, and modifications. The adaptive area detector 940 includes a comparator 1410 (e.g., comp2), a comparator 1412 (e.g., comp3), an operational amplifier 1414 (e.g., opa3), a transconductance amplifier 1420 (e.g., Gm), a flip-flop 1422 (e.g., dff3), a one-shot pulse generator 1424, a transistor 1426, AND gates 1430, 1432, 1434 and 1436, switches 1440, 1442, 1444, 1446, 1448, 1450, 1452 and 1454, resistors 1460 and 1462, and capacitors 1464, 1466 and 1468. For example, the flip-flop 1422 (e.g., dff3) is a D flip-flop. As an example, the signal-pulse generator 1424 generates one or more pulses that are at a high voltage level (e.g., at a high-voltage level that corresponds to a logic high level).

According to some embodiments, the flip-flop 1422 (e.g., dff3) generates a signal 1421 (e.g., Vds_det_2) and a signal 1423 (e.g., Vds_det_2i). In certain examples, the AND gate 1430 generates a logic signal 1431 (e.g., sum1), the AND gate 1432 generates a logic signal 1433 (e.g., sum2), the AND gate 1434 generates a logic signal 1435 (e.g., clr2), and the AND gate 1436 generates a logic signal 1437 (e.g., clr1). For example, the switch 1440 (e.g., sw3) receives a signal 1441 (e.g., SP2) to open and/or close the switch 1440, and the switch 1442 (e.g., sw4) receives a signal 1443 (e.g., RS2) to open and/or close the switch 1442. As an example, the switch 1444 (e.g., sw5) receives the logic signal 1431 (e.g., sum1) to open and/or close the switch 1444, the switch 1446 (e.g., sw6) receives the logic signal 1435 (e.g., clr2) to open and/or close the switch 1446, and the switch 1448 (e.g., sw7) receives the signal 1421 (e.g., Vds_det_2) to open and/or close the switch 1448. For example, the switch 1450 (e.g., sw8) receives the logic signal 1433 (e.g., sum2) to open and/or close the switch 1450, the switch 1452 (e.g., sw9) receives the logic signal 1437 (e.g., clr1) to open and/or close the switch 1452, and the switch 1454 (e.g., sw10) receives the signal 1423 (e.g., Vds_det_2i) to open and/or close the switch 1454.

In certain embodiments, an inverting input terminal (e.g., the “−” terminal) of the comparator 1410 (e.g., comp2) receives a voltage 1411. For example, the voltage 1411 is the voltage 1243 as shown in FIG. 12. As an example, the voltage 1411 is equal to

$$\frac{{V}_{dsp ( n )}}{m} \times {k}_{r} ,$$

where V_{dsp(n)} represents the peak magnitude of the voltage 832, m represents the predetermined divider constant (e.g., 40) of the voltage divider 910, and kᵣ represents a predetermined constant (e.g., 0.5).

In some embodiments, an output terminal of the transconductance amplifier 1420 (e.g., Gm) is connected to area holding circuits 1470 and 1472. For example, the area holding circuit 1470 includes the switch 1444 (e.g., sw5), the switch 1446 (e.g., sw6), the switch 1448 (e.g., sw7), and the capacitor 1464. As an example, the area holding circuit 1472 includes the switch 1450 (e.g., sw8), the switch 1452 (e.g., sw9), the switch 1454 (e.g., sw10), and the capacitor 1466. In certain embodiments, the area holding circuit 1470 and the area holding circuit 1472 operate alternately. For example, the capacitor 1464 of the area holding circuit 1470 is charged to a voltage 1465, which indicates an actual area (e.g., Sₙ) for the voltage difference from the voltage 832 to the voltage at the terminal 868 (e.g., GND) divided by a predetermined divider constant (e.g., m) of the voltage divider 910. As an example, the capacitor 1466 of the area holding circuit 1472 is charged to a voltage 1467, which indicates an actual area (e.g., Sₙ) for the voltage difference from the voltage 832 to the voltage at the terminal 868 (e.g., GND) divided by a predetermined divider constant (e.g., m) of the voltage divider 910.

According to certain embodiments, at a rising edge of the voltage 892 (e.g., a drive voltage) when the voltage 892 changes from a logic low level to a logic high level, a signal 1443 (e.g., RS2) provides a narrow pulse to briefly close the switch 1442 (e.g., sw4) in order to discharge the capacitor 1468 (e.g., C6), and then the signal 1421 (e.g., Vds_det_2) provides a pulse with a predetermined width to connect the capacitors 1464 and 1468 or the signal 1423 (e.g., Vds_det_2i) provides a pulse with a predetermined width to connect the capacitors 1466 and 1468. For example, the capacitor 1468 is charged by the capacitor 1464 or the capacitor 1466 to provide a voltage 1469. As an example, the voltage 1469 is determined as follows:

$${V}_{1469} = \frac{{C}_{5}}{{C}_{5} + {C}_{6}} \times \frac{{S}_{( n )}}{m} \qquad ( Equation 8 )$$

where V₁₄₆₉ represents the voltage 1469. Additionally, C₅ represents the capacitance of the capacitor 1464 or the capacitor 1466, and C₆ represents the capacitance of the capacitor 1468. Also, S₍ₙ₎ represents an actual area (e.g., Sₙ) for the voltage difference from the voltage 832 to the voltage at the terminal 868 (e.g., GND). Moreover, m represents the predetermined divider constant of the voltage divider 910.

According to some embodiments, the voltage 1469 is received by a buffer stage that includes the operational amplifier 1414 (e.g., opa3), the resistor 1460 (e.g., R5), the resistor 1462 (e.g., R4), and the transistor 1426. In certain examples, the resistor 1460 (e.g., R5) includes terminals 1480 and 1482, and the resistor 1462 (e.g., R4) includes terminals 1484 and 1486. For example, the terminal 1486 is biased to the ground voltage on the secondary side of the flyback power converter 600 and/or the flyback power converter 700. As an example, the terminals 1484 and 1482 are both connected to an inverting input terminal (e.g., the “−” terminal) of the operational amplifier 1414 (e.g., opa3). For example, the terminal 1480 is connected to the transistor 1426 and is biased to a voltage 1483. In some examples, the voltage 1483 is determined as follows:

$${V}_{1483} = ( \frac{{C}_{5}}{{C}_{5} + {C}_{6}} \times \frac{{R}_{4} + {R}_{5}}{{R}_{4}} ) \times \frac{{S}_{( n )}}{m} \qquad ( Equation 9 )$$

where V₁₄₈₃ represents the voltage 1483. Additionally, C₅ represents the capacitance of the capacitor 1464 or the capacitor 1466, C₆ represents the capacitance of the capacitor 1468, R₄ represents the resistance of the resistor 1462, and R₅ represents the resistance of the resistor 1460. Also, S₍ₙ₎ represents an actual area (e.g., Sₙ) for the voltage difference from the voltage 832 to the voltage at the terminal 868 (e.g., GND). Moreover, m represents the predetermined divider constant of the voltage divider 910.

In certain embodiments, the comparator 1412 (e.g., comp3) includes a non-inverting input terminal 1492 (e.g., the “+” input terminal), an inverting input terminal 1494 (e.g., the “−” input terminal), and an output terminal 1496. For example, the non-inverting input terminal 1492 (e.g., the “+” input terminal) receives the voltage 1483. As an example, the inverting input terminal 1494 (e.g., the “−” input terminal) receives the voltage 1465 of the capacitor 1464 or the voltage 1467 of the capacitor 1466. In some examples, the comparator 1412 (e.g., comp3) generates the signal 942 (e.g., ctrl_int) and outputs the signal 942 (e.g., ctrl_int) at the output terminal 1496. For example, if the voltage 1483 is larger than the voltage 1465 or the voltage 1467, the signal 942 (e.g., ctrl_int) is at a logic high level, not allowing the voltage 892 (e.g., a drive voltage) to change from the logic low level to the logic high level. As an example, if the voltage 1483 is smaller than the voltage 1465 or the voltage 1467, the signal 942 (e.g., ctrl_int) is at a logic low level, allowing the voltage 892 (e.g., a drive voltage) to change from the logic low level to the logic high level.

Some embodiments of the present invention provide a controller for synchronous rectification (e.g., the controller 860) for a flyback power converter (e.g., the flyback power converter 600 and/or the flyback power converter 700) in order to avoid turning on a transistor on the secondary side (e.g., the transistor 680 and/or the transistor 780) during the resonance of a voltage difference from the drain terminal to the source terminal of the transistor and in order to improve the reliability of synchronous rectification.

Certain embodiments of the present invention provide a controller for synchronous rectification (e.g., the controller 860) that can effectively differentiate a normal waveform from a resonant waveform for a voltage difference from the drain terminal to the source terminal of a transistor on the secondary side (e.g., the transistor 680 and/or the transistor 780), wherein the normal waveform is caused by turning on and/or turning off of a transistor on the primary side (e.g., the transistor 650 and/or the transistor 750) of a flyback power converter (e.g., the flyback power converter 600 and/or the flyback power converter 700). For example, the controller for synchronous rectification (e.g., the controller 860) therefore prevents the transistor on the secondary side (e.g., the transistor 680 and/or the transistor 780) from being turned on during the resonance of the voltage difference. As an example, the controller for synchronous rectification (e.g., the controller 860) therefore reduces and/or removes a voltage spike of the voltage difference and improves the reliability of synchronous rectification.

Some embodiments of the present invention provide a controller for synchronous rectification (e.g., the controller 860) that is used in a power converter with zero voltage switching (ZVS) (e.g., the flyback power converter 600 and/or the flyback power converter 700). For example, the power converter (e.g., the flyback power converter 600 and/or the flyback power converter 700) uses zero voltage switching (ZVS) on the primary side, and the ZVS mechanism causes a voltage difference from the drain terminal to the source terminal of a transistor on the secondary side (e.g., the transistor 680 and/or the transistor 780) to fall quickly at one or more falling edges during resonance of the voltage difference. As an example, the controller for synchronous rectification (e.g., the controller 860) can avoid turning on the transistor on the secondary side (e.g., the transistor 680 and/or the transistor 780) during resonance and also avoid mistakenly turning on synchronous rectification.

Certain embodiments of the present invention provide a controller for synchronous rectification (e.g., the controller 860) that can effectively differentiate a normal waveform from a resonant waveform for a voltage difference from the drain terminal to the source terminal of a transistor on the secondary side (e.g., the transistor 680 and/or the transistor 780) in order to prevent the transistor on the secondary side (e.g., the transistor 680 and/or the transistor 780) from being turned on during resonance, wherein the normal waveform is caused by turning on and/or turning off of a transistor on the primary side (e.g., the transistor 650 and/or the transistor 750) of a flyback power converter (e.g., the flyback power converter 600 and/or the flyback power converter 700) based at least in part on a minimum off-time duration for the transistor 680 and/or the transistor 780 in the current switching cycle, a falling-edge slope for the voltage difference from the drain terminal to the source terminal of the transistor on the secondary side (e.g., the transistor 680 and/or the transistor 780) using a reference voltage for the current switching cycle, and/or an area under the waveform (e.g., the waveform 1162) for the voltage difference from the drain terminal to the source terminal of the transistor on the secondary side (e.g., the transistor 680 and/or the transistor 780) using another reference voltage and a reference area for the current switching cycle.

Some embodiments of the present invention provide a controller for synchronous rectification (e.g., the controller 860) for a flyback power converter (e.g., the flyback power converter 600 and/or the flyback power converter 700) in order to prevent a transistor on the secondary side (e.g., the transistor 680 and/or the transistor 780) and a transistor on the primary side (e.g., the transistor 650 and/or the transistor 750) of a flyback power converter (e.g., the flyback power converter 600 and/or the flyback power converter 700) from being turned on at the same time in order to avoid damaging the transistor on the secondary side (e.g., the transistor 680 and/or the transistor 780).

According to certain embodiments, a system for controlling synchronous rectification includes: a first control-signal generator configured to generate a first control signal; a second control-signal generator configured to receive the first control signal for a first switching cycle and generate a second control signal for a second switching cycle based at least in part on the first control signal for the first switching cycle, the first switching cycle preceding the second switching cycle; and a driver configured to receive the first control signal and generate a drive voltage based at least in part on the first control signal; wherein the second control-signal generator is further configured to: process information associated with the first control signal; determine a first time duration when the first control signal remains at a first logic level during the first switching cycle; determine a second time duration based at least in part on the first time duration; and generate the second control signal representing the second time duration for the second switching cycle; wherein the first control-signal generator configured to, during the second switching cycle, keep the first control signal at the first logic level for at least the second time duration. For example, the system for controlling synchronous rectification is implemented according to at least FIG. 8, FIG. 9, FIG. 10, and/or FIG. 13.

As an example, the first control-signal generator includes a flip-flop configured to generate the first control signal. For example, the first switching cycle precedes immediately the second switching cycle. As an example, the first logic level is a logic low level. For example, the second control-signal generator is further configured to set the second time duration equal to the first time duration multiplied by a predetermined constant. As an example, the predetermined constant is a positive number smaller than one. For example, the predetermined constant is equal to 0.75.

According to some embodiments, a system for controlling synchronous rectification includes: a first terminal configured to receive a first voltage; a second terminal configured to receive a second voltage, a voltage difference being equal to the second voltage minus the first voltage, the voltage difference as a function of time being represented by a voltage-difference waveform; a third terminal configured to output a drive voltage; a control-signal generator configured to process information associated with the voltage difference and generate a control signal based on at least information associated with the voltage difference; and a driver configured to process information associated with the control signal and generate the drive voltage based at least in part on the control signal; wherein the control-signal generator is further configured to: detect a first peak of the voltage difference; determine a reference voltage based on at least information associated with the first peak; determine a first actual area corresponding to the first peak under the voltage-difference waveform above the reference voltage; and determine a reference area based at least in part on the first actual area; wherein the control-signal generator is further configured to: determine a second actual area corresponding to a second peak under the voltage-difference waveform above the reference voltage, the second peak following the first peak; and process information associated with the second actual area and the reference area; wherein the control-signal generator is further configured to, if the second actual area is smaller than the reference area, generate the control signal at a first logic level; and not allow the drive voltage to change from a second logic level to a third logic level. For example, the system for controlling synchronous rectification is implemented according to at least FIG. 8, FIG. 9, FIG. 11, and/or FIG. 14.

As an example, the control-signal generator is further configured to set the reference voltage equal to a magnitude of the first peak multiplied by a first predetermined constant. For example, the first predetermined constant is a positive number smaller than one. As an example, the first predetermined constant is equal to 0.5. For example, the control-signal generator is further configured to set the reference area equal to the first actual area multiplied by a second predetermined constant. As an example, the second predetermined constant is a positive number smaller than one. For example, the second predetermined constant is equal to 0.75. As an example, the second peak follows immediately the first peak. For example, the second peak is separated from the first peak by one or more additional peaks.

As an example, the control-signal generator is further configured to compare the second actual area with the reference area. For example, the control-signal generator is further configured to, if the second actual area is larger than the reference area, generate the control signal at a fourth logic level; wherein the fourth logic level is different from the first logic level. As an example, the control-signal generator is further configured to, if the second actual area is larger than the reference area, allow the drive voltage to change from the second logic level to the third logic level. For example, the first logic level is a logic high level; and the fourth logic level is a logic low level. As an example, the second logic level is a logic low level; and the third logic level is a logic high level.

According to certain embodiments, a system for controlling synchronous rectification includes: a first terminal configured to receive a first voltage; a second terminal configured to receive a second voltage, a voltage difference being equal to the second voltage minus the first voltage; a third terminal configured to output a drive voltage; a control-signal generator configured to process information associated with the voltage difference and generate a control signal based on at least information associated with the voltage difference; and a driver configured to process information associated with the control signal and generate the drive voltage based at least in part on the control signal; wherein the control-signal generator is further configured to: detect a first peak of the voltage difference; determine a reference voltage based on at least information associated with the first peak; detect a second peak of the voltage difference, the second peak following the first peak; and process information associated with the second peak and the reference voltage; wherein the control-signal generator is further configured to, if a magnitude of the second peak is smaller than the reference voltage, generate the control signal at a first logic level; and not allow the drive voltage to change from a second logic level to a third logic level; wherein the control-signal generator is further configured to, if the magnitude of the second peak is larger than the reference voltage, determine a time duration for the voltage difference to decrease from the reference voltage to a threshold voltage; and if the time duration is larger than a predetermined duration, generate the control signal at the first logic level; and not allow the drive voltage to change from the second logic level to the third logic level. For example, the system for controlling synchronous rectification is implemented according to at least FIG. 8, FIG. 9, FIG. 10, and/or FIG. 12.

As an example, the control-signal generator is further configured to set the reference voltage equal to a magnitude of the first peak multiplied by a predetermined constant. For example, the predetermined constant is a positive number smaller than one. As an example, the predetermined constant is equal to 0.75. For example, the second peak follows immediately the first peak. As an example, the second peak is separated from the first peak by one or more additional peaks. For example, the control-signal generator is further configured to, if the magnitude of the second peak is larger than the reference voltage and if the time duration is smaller than the predetermined duration, generate the control signal at a fourth logic level; wherein the fourth logic level is different from the first logic level. As an example, the control-signal generator is further configured to, if the magnitude of the second peak is larger than the reference voltage and if the time duration is smaller than the predetermined duration, allow the drive voltage to change from the second logic level to the third logic level. For example, the first logic level is a logic high level; and the fourth logic level is a logic low level. As an example, the second logic level is a logic low level; and the third logic level is a logic high level.

According to some embodiments, a method for controlling synchronous rectification includes: generating a first control signal; receiving the first control signal for a first switching cycle; generating a second control signal for a second switching cycle based at least in part on the first control signal for the first switching cycle, the first switching cycle preceding the second switching cycle; and generating a drive voltage based at least in part on the first control signal; wherein the generating a second control signal for a second switching cycle includes: processing information associated with the first control signal; determining a first time duration when the first control signal remains at a first logic level during the first switching cycle; determining a second time duration based at least in part on the first time duration; and generating the second control signal representing the second time duration for the second switching cycle; wherein the generating a first control signal includes, during the second switching cycle, keeping the first control signal at the first logic level for at least the second time duration. For example, the method for controlling synchronous rectification is implemented according to at least FIG. 8, FIG. 9, FIG. 10, and/or FIG. 13.

According to certain embodiments, a method for controlling synchronous rectification includes: receiving a first voltage; receiving a second voltage, a voltage difference being equal to the second voltage minus the first voltage, the voltage difference as a function of time being represented by a voltage-difference waveform; outputting a drive voltage; processing information associated with the voltage difference; generating a control signal based on at least information associated with the voltage difference; processing information associated with the control signal; and generating the drive voltage based at least in part on the control signal; wherein the processing information associated with the voltage difference includes: detecting a first peak of the voltage difference; determining a reference voltage based on at least information associated with the first peak; determining a first actual area corresponding to the first peak under the voltage-difference waveform above the reference voltage; and determining a reference area based at least in part on the first actual area; wherein the processing information associated with the voltage difference further includes: determining a second actual area corresponding to a second peak under the voltage-difference waveform above the reference voltage, the second peak following the first peak; and processing information associated with the second actual area and the reference area; wherein the generating a control signal based on at least information associated with the voltage difference includes, if the second actual area is smaller than the reference area, generating the control signal at a first logic level; and not allowing the drive voltage to change from a second logic level to a third logic level. For example, the method for controlling synchronous rectification is implemented according to at least FIG. 8, FIG. 9, FIG. 11, and/or FIG. 14.

According to some embodiments, a method for controlling synchronous rectification includes: receiving a first voltage; receiving a second voltage, a voltage difference being equal to the second voltage minus the first voltage; outputting a drive voltage; processing information associated with the voltage difference; generating a control signal based on at least information associated with the voltage difference; processing information associated with the control signal; and generating the drive voltage based at least in part on the control signal; wherein the processing information associated with the voltage difference includes: detecting a first peak of the voltage difference; determining a reference voltage based on at least information associated with the first peak; detecting a second peak of the voltage difference, the second peak following the first peak; and processing information associated with the second peak and the reference voltage; wherein the generating a control signal based on at least information associated with the voltage difference includes, if a magnitude of the second peak is smaller than the reference voltage, generating the control signal at a first logic level; and not allowing the drive voltage to change from a second logic level to a third logic level; wherein the generating a control signal based on at least information associated with the voltage difference further includes, if the magnitude of the second peak is larger than the reference voltage, determining a time duration for the voltage difference to decrease from the reference voltage to a threshold voltage; and if the time duration is larger than a predetermined duration, generating the control signal at the first logic level; and not allowing the drive voltage to change from the second logic level to the third logic level. For example, the method for controlling synchronous rectification is implemented according to at least FIG. 8, FIG. 9, FIG. 10, and/or FIG. 12.

For example, some or all components of various embodiments of the present invention each are, individually and/or in combination with at least another component, implemented using one or more software components, one or more hardware components, and/or one or more combinations of software and hardware components. As an example, some or all components of various embodiments of the present invention each are, individually and/or in combination with at least another component, implemented in one or more circuits, such as one or more analog circuits and/or one or more digital circuits. For example, various embodiments and/or examples of the present invention can be combined.

Although specific embodiments of the present invention have been described, it will be understood by those of skill in the art that there are other embodiments that are equivalent to the described embodiments. Accordingly, it is to be understood that the invention is not to be limited by the specific illustrated embodiments.

1.-21. (canceled)

22. A system for controlling synchronous rectification, the system comprising:
a first terminal configured to receive a first voltage;
a second terminal configured to receive a second voltage, a voltage difference being equal to the second voltage minus the first voltage;
a third terminal configured to output a drive voltage;
a control-signal generator configured to process information associated with the voltage difference and generate a control signal based on at least information associated with the voltage difference; and
a driver configured to process information associated with the control signal and generate the drive voltage based at least in part on the control signal;
wherein the control-signal generator is further configured to:
detect a first peak of the voltage difference;
determine a reference voltage based on at least information associated with the first peak;
detect a second peak of the voltage difference, the second peak following the first peak; and
process information associated with the second peak and the reference voltage;
wherein the control-signal generator is further configured to, if a magnitude of the second peak is smaller than the reference voltage,
generate the control signal at a first logic level; and
not allow the drive voltage to change from a second logic level to a third logic level;
wherein the control-signal generator is further configured to, if the magnitude of the second peak is larger than the reference voltage,
determine a time duration for the voltage difference to decrease from the reference voltage to a threshold voltage; and
if the time duration is larger than a predetermined duration,
generate the control signal at the first logic level; and
not allow the drive voltage to change from the second logic level to the third logic level.

23. The system of claim 22 wherein the control-signal generator is further configured to set the reference voltage equal to a magnitude of the first peak multiplied by a predetermined constant.

24. The system of claim 23 wherein the predetermined constant is a positive number smaller than one.

25. The system of claim 24 wherein the predetermined constant is equal to 0.75.

26. The system of claim 22 wherein the second peak follows immediately the first peak.

27. The system of claim 22 wherein the second peak is separated from the first peak by one or more additional peaks.

28. The system of claim 22 wherein:
the control-signal generator is further configured to, if the magnitude of the second peak is larger than the reference voltage and if the time duration is smaller than the predetermined duration, generate the control signal at a fourth logic level;
wherein the fourth logic level is different from the first logic level.

29. The system of claim 28 wherein the control-signal generator is further configured to, if the magnitude of the second peak is larger than the reference voltage and if the time duration is smaller than the predetermined duration, allow the drive voltage to change from the second logic level to the third logic level.

30. The system of claim 28 wherein:
the first logic level is a logic high level; and
the fourth logic level is a logic low level.

31. The system of claim 22 wherein:
the second logic level is a logic low level; and
the third logic level is a logic high level.

32.-33. (canceled)

34. A method for controlling synchronous rectification, the method comprising:
receiving a first voltage;
receiving a second voltage, a voltage difference being equal to the second voltage minus the first voltage;
outputting a drive voltage;
processing information associated with the voltage difference;
generating a control signal based on at least information associated with the voltage difference;
processing information associated with the control signal; and
generating the drive voltage based at least in part on the control signal;
wherein the processing information associated with the voltage difference includes:
detecting a first peak of the voltage difference;
determining a reference voltage based on at least information associated with the first peak;
detecting a second peak of the voltage difference, the second peak following the first peak; and
processing information associated with the second peak and the reference voltage;
wherein the generating a control signal based on at least information associated with the voltage difference includes, if a magnitude of the second peak is smaller than the reference voltage,
generating the control signal at a first logic level; and
not allowing the drive voltage to change from a second logic level to a third logic level;
wherein the generating a control signal based on at least information associated with the voltage difference further includes, if the magnitude of the second peak is larger than the reference voltage,
determining a time duration for the voltage difference to decrease from the reference voltage to a threshold voltage; and
if the time duration is larger than a predetermined duration,
generating the control signal at the first logic level; and
not allowing the drive voltage to change from the second logic level to the third logic level.
